(19) United States
(12) Patent Application Publication
(10) Pub. No.: US 2026/0253586 A1
(43) Pub. Date: Aug. 27, 2026

(54) SYSTEM

(71) Applicant: SoftBank Group Corp., Tokyo (JP)

(72) Inventor: Jaewoo KOO, Tokyo (JP)

(73) Assignee: SoftBank Group Corp., Tokyo (JP)

(21) Appl. No.: 19/537,485

(22) Filed: Feb. 12, 2026

(30) Foreign Application Priority Data
Feb. 21, 2025 (JP) 2025-027086

(51) Int. Cl. G10L 15/22; G06F 16/9535

(52) U.S. Cl. CPC G10L 15/22; G06F 16/9535

(57) ABSTRACT

The system according to the embodiment comprises a reception unit, an analysis unit, a storage unit, and a navigation unit. The reception unit is configured to receive experience information from a user. The analysis unit is configured to analyze the information received by the reception unit. The storage unit is configured to accumulate the information analyzed by the analysis unit. The navigation unit is configured to perform navigation based on the information accumulated by the storage unit.

### CROSS-REFERENCE TO RELATED APPLICATION

The present application claims priority to and incorporates by reference the entire contents of Japanese Patent Application No. 2025-027086 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, navigation systems have been limited to guidance based on map information and have not sufficiently utilized users' experience information, leaving room for improvement.

### SUMMARY OF THE INVENTION

The system according to the embodiment comprises a reception unit, an analysis unit, a storage unit, and a navigation unit. The reception unit is configured to receive experience information from a user. The analysis unit is configured to analyze the information received by the reception unit. The storage unit is configured to accumulate the information analyzed by the analysis unit. The navigation unit is configured to perform navigation based on the information accumulated by the storage unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

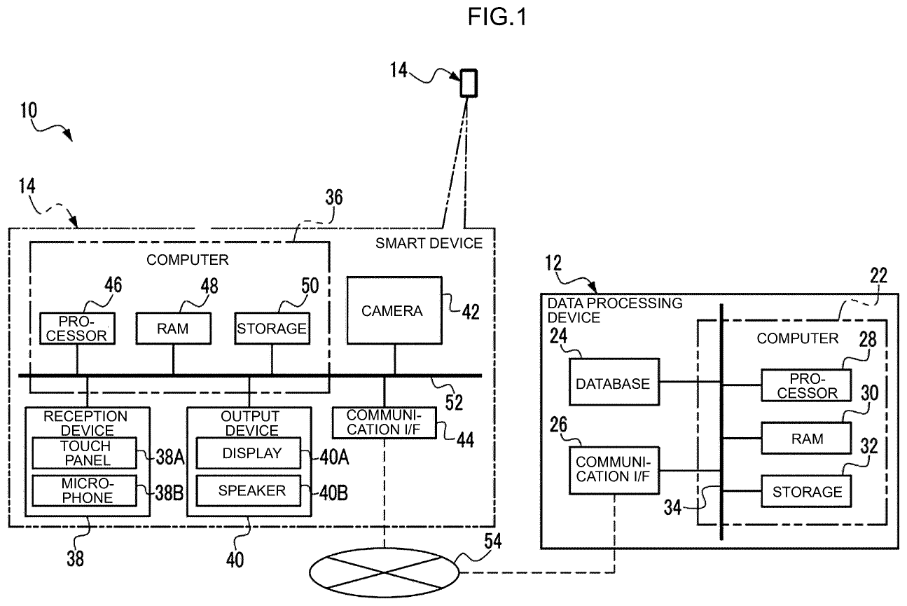

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

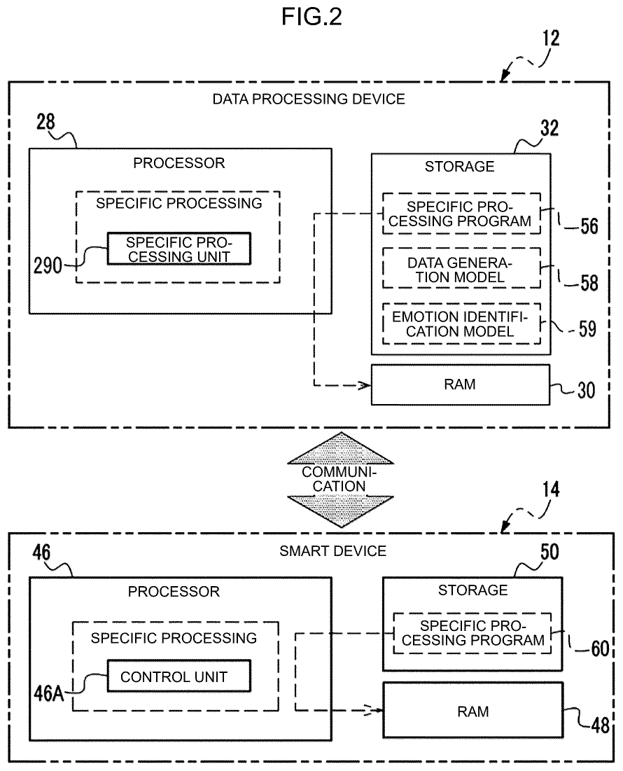

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The navigation system according to the embodiment of the present invention is a system that accumulates not only map information but also information based on driving experience and utilizes it as an assistant. This navigation system allows the user to input experience information obtained while driving, which is analyzed by AI and accumulated. Next, when the navigation system provides route guidance to the user in real time, it takes into account the accumulated experience information. For example, it provides advice such as “It is about time to change lanes” or “Be careful as this road is narrow.” As a result, the user can drive safely and efficiently by utilizing not only map information but also information based on driving experience. For example, the user inputs experience information obtained while driving. At this time, the user records points noticed during driving using voice input or text input. For example, information such as “It is difficult to turn right at this intersection” or “This road tends to be congested” is input. This information is analyzed and accumulated by AI. Next, when the navigation system provides route guidance to the user in real time, it takes into account the accumulated experience information. For example, when the user approaches a specific intersection, advice such as “Be careful as it is difficult to turn right at this intersection” is provided. Also, when the user changes lanes, advice such as “It is about time to change lanes” is provided. As a result, the user can drive safely and efficiently by utilizing not only map information but also information based on driving experience. With this mechanism, the navigation system can provide more accurate route guidance by considering not only map information but also information based on driving experience. For example, even when the user drives on a road for the first time, it is possible to drive safely and efficiently by utilizing information based on past driving experience. In addition, information based on driving experience can be shared with other users, contributing to the improvement of overall driving skills. Thus, the navigation system can provide more accurate route guidance by utilizing information based on the user's driving experience. Specifically, this navigation system comprises a reception unit that receives voice input (e.g., 16 kHz sampled audio waveform data from a smartphone microphone, audio clips of about 3 to 10 seconds in length) or text input (e.g., natural language sentences in Japanese or English, up to 256 tokens). The reception unit performs preprocessing such as spectrogram conversion and noise removal for voice input, and converts it to text data using a speech recognition model (e.g., a speech recognition AI combining convolutional neural networks and recurrent neural networks). For text input, it is directly input to a natural language processing AI. The analysis unit performs morphological analysis (e.g., word segmentation, part-of-speech tagging), syntactic analysis (e.g., dependency parsing), and semantic analysis (e.g., BERT or Transformer-based contextual understanding AI) on the received text data, and extracts important keywords (e.g., “right turn,” “congestion,” “narrow road”) and features related to driving situations (e.g., danger score, alert category). The extracted features are stored by the storage unit in a relational database or NoSQL database together with metadata such as time, location information, user ID, and emotion estimation values (e.g., degree of stress, degree of relaxation). The navigation unit receives as input the user's current location (GPS coordinates, speed, direction), driving situation (accelerometer values, lane information), and accumulated experience information in real time, and generates optimal advice sentences (e.g., “Prepare to turn right ahead,” “This road tends to be congested, so detour is recommended”) using inference AI (e.g., reinforcement learning-based route recommendation AI or rule-based AI). The AI output consists of structured data such as advice sentences (natural language text), advice type (alert, route change suggestion, etc.), and confidence score (0.0 to 1.0), and is used for subsequent processing such as threshold judgment (e.g., notify only if confidence is 0.7 or higher) and transfer to user interface display modules. As a technical effect, this system realizes “knowledge sharing of driving experience,” “real-time situation-adaptive advice,” and “individual user optimization,” which were impossible with conventional map-based navigation, and greatly improves the accuracy, safety, and convenience of route guidance through analysis and inference in high-dimensional feature space by AI. Application fields include navigation for general passenger cars, commercial vehicle operation management, driving education support, car sharing services, and traffic safety awareness systems, among others.

The navigation system according to the embodiment comprises a reception unit, an analysis unit, a storage unit, and a navigation unit. The reception unit receives experience information from the user. The experience information from the user may include, for example, points noticed or precautions during driving, but is not limited to such examples. The reception unit records points noticed by the user during driving using, for example, voice input or text input. For example, the reception unit uses speech recognition technology to convert spoken content by the user into text data. The reception unit can also receive information manually input by the user using text input. The analysis unit analyzes the information received by the reception unit using AI. The analysis unit extracts specific keywords from voice input or text input using, for example, natural language processing technology. For example, the analysis unit uses morphological analysis to segment the input sentence into words and extract important keywords. The analysis unit can also use syntactic analysis to analyze the structure of the sentence and understand its meaning. Furthermore, the analysis unit can use semantic analysis to understand the meaning of the input information and generate appropriate advice. The storage unit accumulates the information analyzed by the analysis unit. The storage unit stores the analyzed information using, for example, a database. The storage unit can manage information based on storage format and storage period. For example, the storage unit stores information in a database and can search and retrieve information as needed. The navigation unit performs navigation based on the information accumulated by the storage unit. The navigation unit provides advice to the user in real time, for example. The navigation unit can provide advice to the user at appropriate timing during driving. For example, when the user approaches a specific intersection, the navigation unit provides advice such as “Be careful as it is difficult to turn right at this intersection.” The navigation unit can also provide advice such as “It is about time to change lanes” when the user changes lanes. As a result, the navigation system according to the embodiment can provide more accurate route guidance by utilizing information based on the user's driving experience. Some or all of the above-described processing in the navigation unit may be performed using AI or without using AI. For example, the navigation unit can perform navigation using an AI model that receives as input the information accumulated by the storage unit. Specifically, this navigation system comprises a module that receives voice input (e.g., 16 kHz sampled audio waveform data from a smartphone microphone, audio clips of about 3 to 10 seconds in length) or text input (e.g., natural language sentences in Japanese or English, up to 256 tokens) as the reception unit. For voice input, the reception unit performs preprocessing such as spectrogram conversion and noise removal, and converts it to text data using a speech recognition AI that combines convolutional neural networks and recurrent neural networks. For text input, it is directly input to a natural language processing AI. The analysis unit performs morphological analysis (word segmentation, part-of-speech tagging), syntactic analysis (dependency parsing), and semantic analysis (Transformer-based contextual understanding AI) on the received text data, and extracts important keywords (e.g., “right turn,” “congestion,” “narrow road”) and features related to driving situations (danger score, alert category). The extracted features are stored by the storage unit in a relational database or NoSQL database together with metadata such as time, location information, user ID, and emotion estimation values (degree of stress, degree of relaxation). The navigation unit receives as input the user's current location (GPS coordinates, speed, direction), driving situation (accelerometer values, lane information), and accumulated experience information in real time, and generates optimal advice sentences (e.g., “Prepare to turn right ahead,” “This road tends to be congested, so detour is recommended”) using reinforcement learning-based route recommendation AI or rule-based AI. The AI output consists of structured data such as advice sentences (natural language text), advice type (alert, route change suggestion, etc.), and confidence score (0.0 to 1.0), and is used for subsequent processing such as threshold judgment (notify only if confidence is 0.7 or higher) and transfer to user interface display modules. As a technical effect, this system realizes “knowledge sharing of driving experience,” “real-time situation-adaptive advice,” and “individual user optimization,” which were impossible with conventional map-based navigation, and greatly improves the accuracy, safety, and convenience of route guidance through analysis and inference in high-dimensional feature space by AI. Application fields include navigation for general passenger cars, commercial vehicle operation management, driving education support, car sharing services, and traffic safety awareness systems, among others.

The navigation system comprises an input unit configured to receive voice input or text input. The input unit receives voice input or text input. For voice input, speech recognition technology can be used, for example. For example, the input unit collects the user's voice using a microphone and converts it into text data using speech recognition technology. The input unit can also receive information manually input by the user using text input. For example, the input unit receives text data input by the user using keyboard input or touch input. By receiving voice input or text input, it becomes easier for the user to record points noticed during driving. Some or all of the above-described processing in the input unit may be performed using AI or without using AI. For example, the input unit can receive voice input using an AI model that converts voice data into text data using speech recognition technology. Specifically, the input unit acquires voice data spoken by the user while driving (e.g., 16 kHz sampled PCM waveform, 3 to 10 seconds audio clip) from a microphone. The input unit performs preprocessing such as spectrogram conversion and noise removal using a band-pass filter on the voice data. The input unit inputs the preprocessed voice data into a speech recognition AI model that combines a convolutional neural network (CNN) and a recurrent neural network (RNN). Examples of input to the AI model include Japanese voice clips such as “It is difficult to turn right at this intersection” or “This road tends to be congested,” and English voice clips such as “The road is narrow here.” The AI model receives an audio waveform tensor (e.g., 1×160000 float array) as input and generates string data (e.g., “It is difficult to turn right at this intersection”) as output. For text input, the input unit directly receives text input from the user's smartphone or in-vehicle terminal keyboard, touch panel, or text converted from voice. The input data is a natural language sentence of up to 256 tokens, and examples include “Be careful as this road is narrow” or “Turn left at the next signal.” The input unit transfers the received text data as input to a natural language processing AI. The output of the AI model is structured data such as the recognized text sentence, confidence score (0.0 to 1.0), and input type (voice-derived/manual input). The input unit can perform threshold judgment, such as transferring to subsequent processing only if the confidence score is 0.7 or higher. As a result, the input unit realizes technical improvements such as high-precision voice recognition by AI, noise resistance, multilingual support, and input type determination, compared to conventional simple voice recognition or manual input reception. As a technical effect, the input unit provides an environment in which the user can record experience information safely and quickly in a hands-free manner while driving, reduces input errors and recognition mistakes, and greatly improves the reliability and convenience of the entire driving support system. Application fields include driving support for general passenger cars, operation recording for commercial vehicles, driving education systems, and traffic safety awareness applications.

The navigation system comprises a sensor unit configured to receive location information or sensor information of a smartphone. The sensor unit receives location information or sensor information of a smartphone. For location information, GPS or Wi-Fi location information can be used, for example. For example, the sensor unit acquires the user's current location using the GPS function of the smartphone. The sensor unit can also acquire the user's current location using Wi-Fi location information. For sensor information, information from an accelerometer or gyroscope can be used, for example. For example, the sensor unit acquires the user's driving situation using the accelerometer of the smartphone. The sensor unit can also acquire the user's driving situation using the gyroscope. By receiving location information or sensor information of a smartphone, information corresponding to the driving situation can be acquired. Some or all of the above-described processing in the sensor unit may be performed using AI or without using AI. For example, the sensor unit can receive sensor information using an AI model that analyzes driving situations based on sensor information of a smartphone. Specifically, the sensor unit receives as input GPS location information acquired from a smartphone (e.g., structure including latitude/longitude float values, altitude, timestamp), Wi-Fi location information (e.g., array of BSSID list of surrounding access points and RSSI values), accelerometer data (e.g., time series array of 3-axis acceleration values, sampling rate 100 Hz, 1000×3 float array for 10 seconds), gyroscope data (e.g., time series array of 3-axis angular velocity values), and so on. The sensor unit performs preprocessing such as outlier removal, low-pass filtering, coordinate transformation (e.g., conversion to map coordinate system), and time series window segmentation on these raw data. As AI models, recurrent neural networks (RNN), long short-term memory networks (LSTM), or Transformer-based time series analysis AI specialized for time series data analysis can be used. Examples of input to the AI include (1) continuous value array of GPS location information (e.g., latitude 35.6895, longitude 139.6917, altitude 44.0, timestamp 2024-06-01T12:34:56Z), (2) time series data of accelerometer for 10 seconds (e.g., ax=[0.01, 0.02, . . . ], ay=[−0.01, 0.00, . . . ], az=[0.98, 0.99, . . . ]), (3) Wi-Fi scan results (e.g., BSSID_1: −60 dBm, BSSID_2: −75 dBm, . . . ), and so on. The AI model outputs features of driving situations (e.g., detection of rapid acceleration/deceleration events, lane change estimation, stop/start judgment, driving environment classification (highway/city/residential area, etc.)). The output format of the AI includes (a) driving situation labels (e.g., “sudden braking,” “normal driving,” “lane change,” etc.), (b) event occurrence probability (e.g., rapid acceleration event probability 0.85), (c) driving state score for each time series segment (e.g., continuous value array from 0.0 to 1.0), and so on. These outputs are used as input for subsequent driving situation judgment modules or the navigation unit, and are utilized for branching processing such as “prioritize alert advice in sections with frequent sudden braking” or “emphasize detailed route guidance during city driving.” As a technical effect, the sensor unit realizes high-dimensional time series feature extraction, integrated analysis of multiple sensors, enhanced noise resistance, and real-time driving situation estimation by AI, compared to conventional simple location information acquisition or sensor value recording, and greatly improves the situation recognition accuracy, advice suitability, and safety of the entire navigation system. Application fields include operation management of general passenger cars and commercial vehicles, driving behavior monitoring, insurance telematics, driving education support, traffic safety awareness systems, and smart city-linked mobility services.

The analysis unit can analyze voice input using natural language processing and extract specific keywords. The analysis unit analyzes voice input using natural language processing and extracts specific keywords. For natural language processing, technologies such as morphological analysis, syntactic analysis, and semantic analysis can be used. For example, the analysis unit uses morphological analysis to segment voice input into words and extract important keywords. The analysis unit can also use syntactic analysis to analyze the structure of voice input and understand its meaning. Furthermore, the analysis unit can use semantic analysis to understand the meaning of voice input and extract appropriate keywords. By using natural language processing, it becomes easier to extract specific keywords from voice input. Some or all of the above-described processing in the analysis unit may be performed using AI or without using AI. For example, the analysis unit can analyze voice input using an AI model that extracts specific keywords from voice input. Specifically, the analysis unit converts voice input (e.g., 16 kHz sampled PCM waveform data, audio clips of 3 to 10 seconds) into text data using a speech recognition AI model, and then performs text analysis using a natural language processing AI model. The analysis unit uses a morphological analysis engine (e.g., word segmentation algorithm, part-of-speech tagger) to segment the input sentence into words and assign part-of-speech and semantic roles to each word. The syntactic analysis module applies dependency parsing and syntax tree generation algorithms (e.g., dependency structure analysis) to clarify relationships such as subject, predicate, and object in the sentence. The semantic analysis module uses a Transformer-based contextual understanding AI (e.g., pre-trained models such as BERT or RoBERTa) to extract semantic feature vectors of the entire sentence and automatically extract important keywords (e.g., “right turn,” “congestion,” “narrow road”) and features related to driving situations (e.g., danger score, alert category). Examples of input to the AI model include Japanese text such as “It is difficult to turn right at this intersection” or “This road tends to be congested,” and English text such as “The road is narrow here.” The output of the AI model includes a list of extracted keywords (e.g., [‘right turn’, ‘difficult’]), driving situation category (e.g., ‘alert’), confidence score (e.g., 0.92), and other structured data. These outputs are used as input for subsequent storage in the database by the storage unit or for real-time advice generation by the navigation unit. As a technical effect, the analysis unit realizes high-dimensional semantic understanding, contextual grasp, multilingual support, and enhanced noise resistance by AI, compared to conventional simple keyword matching or manual tagging, and greatly improves the accuracy, speed, and scalability of information extraction from voice input. Application fields include driving support for general passenger cars and commercial vehicles, driving education systems, traffic safety awareness applications, car sharing services, and smart city-linked mobility services.

The navigation unit may comprise an advice unit configured to provide advice in real time. The navigation unit comprises an advice unit configured to provide advice in real time. The advice unit provides advice to the user during driving at appropriate timing. For example, when the user approaches a specific intersection, the advice unit provides advice such as “Be careful as it is difficult to turn right at this intersection.” The advice unit can also provide advice such as “It is about time to change lanes” when the user changes lanes. By providing advice in real time, appropriate advice can be given to the user during driving. Some or all of the above-described processing in the advice unit may be performed using AI or without using AI. For example, the advice unit can provide advice using an AI model that receives as input information provided by the navigation unit and provides advice in real time. Specifically, the navigation unit acquires the user's current location (GPS coordinates, speed, direction), driving situation (accelerometer values, lane information), and accumulated experience information (e.g., past danger spots, alert history) in real time, and inputs these as data to the advice generation AI model. As AI models, reinforcement learning-based route recommendation AI, rule-based AI, or Transformer-based natural language generation AI can be used in combination. Examples of input to the AI include (1) current location: latitude 35.6895, longitude 139.6917, speed 40 km/h, direction 90 degrees; (2) driving situation: accelerometer values ax=0.02, ay=−0.01, az=0.98; (3) experience information: ‘It is difficult to turn right at this intersection,’ ‘This road tends to be congested,’ and so on. The AI model outputs optimal advice sentences (e.g., “Prepare to turn right ahead,” “This road tends to be congested, so detour is recommended”), advice type (alert, route change suggestion, etc.), and confidence score (0.0 to 1.0) as structured data. Examples of output include (1) advice sentence: “Be careful as it is difficult to turn right at this intersection,” (2) advice type: ‘alert,’ (3) confidence score: 0.85, and so on. These outputs are used for subsequent processing such as threshold judgment (e.g., notify only if confidence is 0.7 or higher) and transfer to user interface display modules. As a technical effect, the navigation unit realizes real-time situation-adaptive advice generation, individual optimization, and inference in high-dimensional feature space by AI, compared to conventional static route guidance or simple map information presentation, and greatly improves the accuracy, safety, and convenience of driving support. Application fields include driving support for general passenger cars and commercial vehicles, operation management, driving education systems, traffic safety awareness applications, and smart city-linked mobility services.

The navigation system may comprise a sharing unit configured to share information with other users. The sharing unit shares information with other users. The sharing unit can share information based on driving experience with other users, for example. For example, the sharing unit provides information based on driving experience input by the user to other users. The sharing unit can also receive information provided by other users and provide it to the user. By sharing information with other users, the overall driving skill can be improved. Some or all of the above-described processing in the sharing unit may be performed using AI or without using AI. For example, the sharing unit can share information using an AI model that receives as input information provided by other users and shares information. Specifically, the sharing unit stores driving experience information input by each user (e.g., text data such as danger spots, congestion information, alert history, and metadata with location information) in a relational database or NoSQL database, and searches, extracts, and distributes related information in response to requests from other users. As AI models, information relevance judgment AI (e.g., similarity calculation AI, clustering AI), reliability evaluation AI (e.g., weighting based on the submitter's driving history or evaluation score), and recommendation AI (e.g., collaborative filtering or graph neural networks) can be used in combination. Examples of input to the AI include (1) sharing request: ‘danger spot information around current location,’ (2) user attributes: 5 years of driving experience, past evaluation score 0.9, (3) other users' experience information: ‘This road has poor visibility at night,’ and so on. The AI model outputs a list of information to be shared (e.g., experience information with relevance scores), priority (e.g., distribute only if confidence is 0.8 or higher), and sharing format (e.g., text, voice, map marker, etc.) as structured data. Examples of output include (1) shared information: ‘It is difficult to turn right at this intersection,’ (2) relevance score: 0.92, (3) distribution format: popup display on map, and so on. These outputs are used for subsequent processing such as transfer to user interface or navigation unit, and push notifications to other user terminals. As a technical effect, the sharing unit realizes relevance judgment, reliability evaluation, automatic recommendation, and real-time sharing by AI, compared to conventional simple bulletin boards or manual sharing, and greatly improves the efficient aggregation, dissemination, and overall optimization of driving experience knowledge. Application fields include driving support for general passenger cars and commercial vehicles, driving education systems, traffic safety awareness applications, car sharing services, and smart city-linked mobility services.

The reception unit is configured to estimate a user's emotion and adjust the timing of receiving experience information based on the estimated emotion of the user. For example, if the user is feeling stressed, the reception unit postpones the reception of experience information so that the user can concentrate on driving. If the user is relaxed, the reception unit allows the user to immediately input points noticed during driving. Furthermore, if the user is in a hurry, the reception unit allows the user to input experience information collectively after driving. By adjusting the timing of receiving experience information according to the user's emotion, an environment is provided in which the user can concentrate on driving. Emotion estimation is realized using, for example, an emotion engine or generative AI with emotion estimation functions. Generative AI may be a text generation AI (e.g., LLM) or multimodal generative AI, but is not limited thereto. Some or all of the above-described processing in the reception unit may be performed using AI or without using AI. For example, the reception unit can estimate emotion using an AI model that receives the user's emotion data as input. Specifically, the reception unit simultaneously acquires multiple biometric sensor data (e.g., heart rate time series data, skin conductance values, facial image frames, audio waveform data), utterance content during driving (e.g., text converted from voice input), and driving behavior data (e.g., frequency of rapid acceleration/deceleration events, steering variation) to estimate the user's emotional state. The reception unit preprocesses these multimodal data (e.g., noise removal, normalization, time series window segmentation, face region extraction) and inputs them to an emotion estimation AI model. As AI models, multimodal emotion estimation AI combining convolutional neural networks (CNN) for facial expression recognition, recurrent neural networks (RNN) or long short-term memory networks (LSTM) for biometric signal time series analysis, and Transformer-based natural language understanding AI for emotion classification of utterance content can be used. Examples of input to the AI include (1) facial image frame (e.g., 224×224 pixel RGB image), (2) heart rate time series (e.g., 10-element float array for 10 seconds at 1-second intervals), (3) utterance text (e.g., “This road is crowded and frustrating”), (4) accelerometer values (e.g., 3-axis data for ax, ay, az), and so on. The AI model outputs structured data such as emotion label (e.g., ‘stress’, ‘relaxation’, ‘tension’, ‘in a hurry’), emotion intensity score (e.g., 0.0 to 1.0), and estimation basis (e.g., facial expression feature vector, frequency of negative words in utterance). Examples of output include (1) emotion label: ‘stress’, emotion intensity: 0.82; (2) emotion label: ‘relaxation’, emotion intensity: 0.15; (3) emotion label: ‘in a hurry’, emotion intensity: 0.67, and so on. Based on these outputs, the reception timing control module applies rule-based or reinforcement learning-based timing optimization algorithms, such as “if stress intensity is 0.7 or higher, display the reception dialog after driving,” “if relaxation intensity is less than 0.3, allow immediate input reception,” and so on. Subsequent processing includes transferring the reception timing judgment result to the user interface control unit and automatically adjusting the display timing and notification method of the input reception dialog (e.g., popup, voice guidance, summary input screen after driving). As a technical effect, the reception unit realizes high-precision emotion estimation, multimodal data integration, and real-time adaptive reception control by AI, compared to conventional uniform input reception or manual timing adjustment, and improves user concentration, safety, input stress reduction, and overall system usability during driving. Application fields include driving support for general passenger cars and commercial vehicles, driving education systems, traffic safety awareness applications, stress management support for professional drivers, and smart city-linked mobility services.

The reception unit is configured to analyze a user's past driving history and select an appropriate reception method. For example, based on experience information frequently input by the user in the past, the reception unit provides a simple input form. The reception unit can also propose input methods (voice, text, etc.) for specific situations based on the user's driving history. Furthermore, the reception unit can analyze the user's driving history and propose the optimal reception method for specific time periods. By analyzing the user's past driving history, the optimal reception method can be provided. Some or all of the above-described processing in the reception unit may be performed using AI or without using AI. For example, the reception unit can select a reception method using an AI model that receives the user's driving history data as input. Specifically, the reception unit acquires driving history data accumulated for each user (e.g., past one year of driving route history, driving time periods, input history (voice/text/image), input content categories (danger spots, congestion, alerts, etc.), input frequency, driving situation at input (speed, weather, traffic volume)) from a relational database or NoSQL database. The reception unit performs preprocessing such as time series feature extraction (e.g., input trends by day of week and time period, input method preferences by driving situation), clustering (e.g., user type classification by K-means), and frequency analysis (e.g., frequency aggregation by input category) on these history data. As AI models, gradient boosting decision trees (GBDT), random forests, or Transformer-based time series pattern recognition AI can be used. Examples of input to the AI include (1) driving history time series (e.g., 2024-06-01 08:00 highway 60 minutes, 2024-06-02 18:30 city 30 minutes), (2) input history (e.g., voice input: 3 times per week, text input: once per week), (3) input content category (e.g., danger spots: 10 cases, congestion: 5 cases), and so on. The AI model outputs structured data such as optimal reception method (e.g., recommend voice input, recommend text input, display simple form, custom input template), reason for recommendation (e.g., past voice input success rate 90%, frequent text input errors at night), and recommendation score (e.g., 0.85). Examples of output include (1) recommended reception method: voice input, recommendation score: 0.92; (2) recommended reception method: simple form, recommendation score: 0.78; (3) recommended reception method: text input, recommendation score: 0.65, and so on. Based on the output of the AI model, the user interface control unit automatically adjusts the layout of the reception screen and input method (voice/text/selection), automatically displays input candidates, and enables input completion functions in real time. Subsequent processing includes using the input method actually selected by the user and input completion rate as feedback data for continuous learning of the AI model, thereby continuously improving the optimization accuracy of the reception method. As a technical effect, the reception unit realizes individual optimization, history pattern learning, and real-time reception method proposal by AI, compared to conventional uniform input reception or user-dependent input method selection, and greatly improves input efficiency, user satisfaction, reduction of input errors, and overall system operation efficiency. Application fields include driving support for general passenger cars and commercial vehicles, driving education systems, traffic safety awareness applications, business record support for professional drivers, and smart city-linked mobility services.

The reception unit is configured to perform filtering at the time of receiving experience information based on the user's current driving situation or area of interest. For example, when the user is driving on a highway, the reception unit receives only information related to specific driving situations. The reception unit can also preferentially receive information related to driving techniques in which the user is interested. Furthermore, the reception unit can filter and receive highly relevant information according to the user's current driving situation. By performing filtering based on the user's driving situation or area of interest, highly relevant information can be received. Some or all of the above-described processing in the reception unit may be performed using AI or without using AI. For example, the reception unit can perform filtering using an AI model that receives the user's driving situation data or area of interest data as input. Specifically, the reception unit simultaneously acquires the user's current driving situation data (e.g., GPS location, speed, direction, accelerometer values, road type (highway/city/residential area, etc.), weather information) and area of interest data registered in the user profile (e.g., driving technique category (eco-driving, night driving, driving in bad weather, etc.), interest area scores extracted from past input history). The reception unit preprocesses these data (e.g., category conversion, normalization, feature vectorization) and inputs them to a filtering AI model. As AI models, gradient boosting decision trees (GBDT), random forests, or Transformer-based multivariate classification AI can be used. Examples of input to the AI include (1) driving situation: highway, speed 90 km/h, weather: rain; (2) area of interest: eco-driving score 0.8, night driving score 0.3; (3) candidate input information: ‘alert for sudden braking’, ‘congestion information’, ‘improved night visibility’, and so on. The AI model outputs structured data such as relevance score for each candidate input information (e.g., 0.0 to 1.0), reception judgment (e.g., receive only if 0.7 or higher), and priority list (e.g., information ID list sorted by relevance). Examples of output include (1) candidate: ‘alert for sudden braking’, relevance 0.92, reception: accepted; (2) candidate: ‘improved night visibility’, relevance 0.35, reception: not accepted; (3) candidate: ‘congestion information’, relevance 0.81, reception: accepted, and so on. Based on the output of the AI model, the user interface control unit displays only highly relevant information on the reception screen and hides or disables low relevance information. Subsequent processing includes using the content and acceptance rate of received information as feedback data for continuous learning of the AI model, thereby continuously improving filtering accuracy. As a technical effect, the reception unit realizes high-dimensional relevance judgment, individual optimization, and real-time reception control by AI, compared to conventional uniform information reception or manual category selection, and greatly improves input efficiency, information usefulness, user satisfaction, and overall system operation efficiency. Application fields include driving support for general passenger cars and commercial vehicles, driving education systems, traffic safety awareness applications, business record support for professional drivers, and smart city-linked mobility services.

The reception unit is configured to estimate a user's emotion and determine the priority of experience information to be received based on the estimated emotion of the user. For example, if the user is feeling stressed, the reception unit preferentially receives highly important information. If the user is relaxed, the reception unit preferentially receives detailed information. Furthermore, if the user is in a hurry, the reception unit preferentially receives concise information. By determining the priority of experience information to be received according to the user's emotion, important information can be preferentially received. Emotion estimation is realized using, for example, an emotion engine or generative AI with emotion estimation functions. Generative AI may be a text generation AI (e.g., LLM) or multimodal generative AI, but is not limited thereto. Some or all of the above-described processing in the reception unit may be performed using AI or without using AI. For example, the reception unit can estimate emotion using an AI model that receives the user's emotion data as input. Specifically, the reception unit simultaneously acquires multiple biometric sensor data (e.g., heart rate time series data, skin conductance values, facial image frames, audio waveform data), utterance content during driving (e.g., text converted from voice input), and driving behavior data (e.g., frequency of rapid acceleration/deceleration events, steering variation) to estimate the user's emotional state. The reception unit preprocesses these multimodal data (e.g., noise removal, normalization, time series window segmentation, face region extraction) and inputs them to an emotion estimation AI model. As AI models, multimodal emotion estimation AI combining convolutional neural networks for facial expression recognition, recurrent neural networks or long short-term memory networks for biometric signal time series analysis, and Transformer-based natural language understanding AI for emotion classification of utterance content can be used. Examples of input to the AI include (1) facial image frame (224×224 pixel RGB image), (2) heart rate time series (10-element float array for 10 seconds at 1-second intervals), (3) utterance text (“This road is crowded and frustrating”), (4) accelerometer values (3-axis data for ax, ay, az), and so on. The AI model outputs structured data such as emotion label (‘stress’, ‘relaxation’, ‘tension’, ‘in a hurry’), emotion intensity score (0.0 to 1.0), and estimation basis (facial expression feature vector, frequency of negative words in utterance). Examples of output include (1) emotion label: ‘stress’, emotion intensity: 0.82; (2) emotion label: ‘relaxation’, emotion intensity: 0.15; (3) emotion label: ‘in a hurry’, emotion intensity: 0.67, and so on. Based on these outputs, the priority determination module applies rule-based or reinforcement learning-based priority optimization algorithms, such as “if stress intensity is 0.7 or higher, preferentially receive information with importance score 0.8 or higher,” “if relaxation intensity is less than 0.3, preferentially receive detailed information,” “if in a hurry intensity is 0.6 or higher, preferentially receive concise information,” and so on. Subsequent processing includes transferring the priority judgment result to the user interface control unit and automatically adjusting the information display order and notification method (popup, voice guidance, summary input screen after driving) on the input reception screen. As a technical effect, the reception unit realizes high-precision emotion estimation, multimodal data integration, and real-time adaptive priority control by AI, compared to conventional uniform input reception or manual priority adjustment, and improves user concentration, safety, input stress reduction, and overall system usability during driving. Application fields include driving support for general passenger cars and commercial vehicles, driving education systems, traffic safety awareness applications, stress management support for professional drivers, and smart city-linked mobility services.

The reception unit is configured to preferentially receive highly relevant information based on the user's geographic location information at the time of receiving experience information. For example, when the user is driving in a specific area, the reception unit preferentially receives information related to that area. The reception unit can also filter and receive highly relevant information based on the user's current location. Furthermore, if the user is interested in a specific area, the reception unit can preferentially receive information related to that area. By considering the user's geographic location information, highly relevant information can be preferentially received. Some or all of the above-described processing in the reception unit may be performed using AI or without using AI. For example, the reception unit can filter highly relevant information using an AI model that receives the user's geographic location information as input. Specifically, the reception unit simultaneously acquires geographic metadata such as GPS location information (latitude, longitude, altitude, timestamp) obtained from a smartphone or in-vehicle terminal, Wi-Fi location information (BSSID list of surrounding access points and RSSI values), area ID on the map, and the user's past visit history or area of interest scores. The reception unit preprocesses these geographic data (coordinate normalization, map tile ID conversion, area clustering) and inputs them to a geographic relevance judgment AI model. As AI models, gradient boosting decision trees, random forests, or Transformer-based geospatial feature extraction AI can be used. Examples of input to the AI include (1) current location: latitude 35.6895, longitude 139.6917, altitude 44.0, timestamp 2024-06-01T12:34:56Z; (2) area ID: ‘Tokyo_Central_001’; (3) past visit history: ‘Shibuya’, ‘Shinjuku’, ‘Ikebukuro’; (4) area of interest scores: ‘highway section 0.8’, ‘residential area 0.2’, and so on. The AI model outputs structured data such as geographic relevance score for each candidate input information (0.0 to 1.0), reception judgment (receive only if 0.7 or higher), and priority list (information ID list sorted by relevance). Examples of output include (1) candidate: ‘congestion information_Shinjuku’, relevance 0.92, reception: accepted; (2) candidate: ‘improved night visibility_Ikebukuro’, relevance 0.35, reception: not accepted; (3) candidate: ‘alert for sudden braking_Shibuya’, relevance 0.81, reception: accepted, and so on. Based on the output of the AI model, the user interface control unit displays only highly geographically relevant information on the reception screen and hides or disables low relevance information. Subsequent processing includes using the content and acceptance rate of received information as feedback data for continuous learning of the AI model, thereby continuously improving geographic filtering accuracy. As a technical effect, the reception unit realizes high-dimensional geospatial feature extraction, individual optimization, and real-time reception control by AI, compared to conventional uniform information reception or manual area selection, and greatly improves input efficiency, information usefulness, user satisfaction, and overall system operation efficiency. Application fields include driving support for general passenger cars and commercial vehicles, driving education systems, traffic safety awareness applications, business record support for professional drivers, and smart city-linked mobility services.

The reception unit is configured to analyze a user's social media activity and receive relevant information at the time of receiving experience information. For example, the reception unit receives relevant information based on driving experience shared by the user on social media. The reception unit can also preferentially receive information related to driving techniques in which the user is interested, based on the user's social media activity. Furthermore, the reception unit can analyze the user's social media activity and filter and receive highly relevant information. By analyzing the user's social media activity, highly relevant information can be received. Some or all of the above-described processing in the reception unit may be performed using AI or without using AI. For example, the reception unit can filter relevant information using an AI model that receives the user's social media data as input. Specifically, the reception unit collects various social media activity data obtained from social media accounts linked by the user (e.g., driving diary posts, traffic information sharing, follow history related to driving techniques), such as post text, post time, location tags, hashtags, image/video metadata, and history of likes, comments, and shares. The reception unit preprocesses these data (natural language normalization, image feature extraction, time series formatting, category tagging) and inputs them to a social relevance judgment AI model. As AI models, Transformer-based natural language understanding AI, image recognition AI, and user interest clustering AI using graph neural networks can be used in combination. Examples of input to the AI include (1) post text: “# congestion # rightturn_difficult Shinjuku intersection”; (2) post image: intersection photo (224×224 pixel RGB image); (3) post time: 2024-06-01T18:00:00Z; (4) hashtags: [‘# ecodrive’, ‘# nightdriving’]; (5) follow history: ‘safe driving course’, ‘congestion information sharing group’, and so on. The AI model outputs structured data such as relevance score for each candidate input information (0.0 to 1.0), reception judgment (receive only if 0.7 or higher), and priority list (information ID list sorted by relevance). Examples of output include (1) candidate: ‘right turn alert_Shinjuku’, relevance 0.91, reception: accepted; (2) candidate: ‘ecodrive recommendation’, relevance 0.85, reception: accepted; (3) candidate: ‘improved night visibility’, relevance 0.42, reception: not accepted, and so on. Based on the output of the AI model, the user interface control unit displays only highly socially relevant information on the reception screen and hides or disables low relevance information. Subsequent processing includes using the content and acceptance rate of received information as feedback data for continuous learning of the AI model, thereby continuously improving social relevance filtering accuracy. As a technical effect, the reception unit realizes high-dimensional social feature extraction, individual optimization, and real-time reception control by AI, compared to conventional uniform information reception or manual selection of areas of interest, and greatly improves input efficiency, information usefulness, user satisfaction, and overall system operation efficiency. Application fields include driving support for general passenger cars and commercial vehicles, driving education systems, traffic safety awareness applications, business record support for professional drivers, and smart city-linked mobility services.

The analysis unit is configured to estimate a user's emotion and adjust the expression method of analysis based on the estimated emotion of the user. For example, if the user is nervous, the analysis unit provides simple and highly visible analysis results. If the user is relaxed, the analysis unit provides detailed analysis results. Furthermore, if the user is in a hurry, the analysis unit provides analysis results that focus on key points. By adjusting the expression method of analysis according to the user's emotion, analysis results that are easy for the user to understand can be provided. Emotion estimation is realized using, for example, an emotion engine or generative AI with emotion estimation functions. Generative AI may be a text generation AI (e.g., LLM) or multimodal generative AI, but is not limited thereto. Some or all of the above-described processing in the analysis unit may be performed using AI or without using AI. For example, the analysis unit can estimate emotion using an AI model that receives the user's emotion data as input. Specifically, the analysis unit simultaneously acquires multimodal data such as facial image frames (e.g., 224×224 pixel RGB image), heart rate time series data (e.g., 10-element float array for 10 seconds at 1-second intervals), audio waveform data (e.g., 16 kHz sampled PCM waveform), utterance content during driving (e.g., text converted from voice input), and accelerometer values (e.g., 3-axis data for ax, ay, az) to estimate the user's emotional state. The analysis unit performs preprocessing such as noise removal, normalization, face region extraction, and time series window segmentation on these data, and inputs them to an emotion estimation AI model (e.g., CNN for facial expression recognition, LSTM for biometric signal analysis, Transformer-based natural language understanding AI for emotion classification of utterance content). Examples of input to the AI model include (1) facial image frame, (2) heart rate time series, (3) utterance text “This road is crowded and frustrating”, (4) accelerometer values, and so on. The AI model outputs structured data such as emotion label (e.g., ‘nervous’, ‘relaxed’, ‘in a hurry’), emotion intensity score (0.0 to 1.0), and estimation basis (facial expression feature vector, frequency of negative words in utterance). Examples of output include (1) emotion label: ‘nervous’, emotion intensity: 0.75; (2) emotion label: ‘relaxed’, emotion intensity: 0.12; (3) emotion label: ‘in a hurry’, emotion intensity: 0.68, and so on. Based on these outputs, the analysis expression control module applies rule-based or reinforcement learning-based expression optimization algorithms, such as “if nervous intensity is 0.7 or higher, display a simple summary”, “if relaxation intensity is less than 0.3, display detailed analysis”, “if in a hurry intensity is 0.6 or higher, display only key points”, and so on. Subsequent processing includes transferring the expression method of analysis results to the user interface control unit and automatically adjusting the display layout and notification method (e.g., popup, voice guidance, detailed screen). As a technical effect, the analysis unit realizes high-precision emotion estimation, multimodal data integration, and real-time adaptive analysis expression control by AI, compared to conventional uniform analysis result display or manual expression adjustment, and enables optimal information presentation according to the user's psychological state and situation, greatly improving understanding, satisfaction, and safety. Application fields include driving support for general passenger cars and commercial vehicles, driving education systems, traffic safety awareness applications, stress management support for professional drivers, and smart city-linked mobility services.

The analysis unit is configured to adjust the level of detail of analysis based on the importance of the experience information at the time of analysis. For example, the analysis unit performs detailed analysis for highly important information. The analysis unit can also perform concise analysis for less important information. Furthermore, the analysis unit can adjust the level of detail of analysis according to the importance of the experience information. By adjusting the level of detail of analysis based on the importance of the experience information, important information can be analyzed in detail. Some or all of the above-described processing in the analysis unit may be performed using AI or without using AI. For example, the analysis unit can adjust the level of detail of analysis using an AI model that receives importance data of experience information as input. Specifically, the analysis unit acquires input data such as importance score assigned to each experience information (e.g., continuous value from 0.0 to 1.0, or category label such as “high,” “medium,” “low”), information type (e.g., danger spot, congestion, alert), occurrence frequency, and past user evaluation score. The analysis unit performs preprocessing such as normalization, category conversion, and feature vectorization on these data, and inputs them to an analysis detail control AI model (e.g., gradient boosting decision tree, random forest, Transformer-based multivariate classification AI). Examples of input to the AI include (1) importance score 0.92, information type “danger spot”; (2) importance score 0.45, information type “congestion”; (3) importance score 0.18, information type “alert”, and so on. The AI model outputs structured data such as analysis detail label (e.g., “detailed analysis,” “standard analysis,” “simple analysis”), analysis item list (e.g., for detailed analysis, add time series graphs, statistics, related information links; for simple analysis, only summary text), and recommended display method (e.g., detailed screen, popup, notification only). Examples of output include (1) detail: “detailed analysis”, item list: [‘time series graph’, ‘statistics’, ‘related links’]; (2) detail: “simple analysis”, item list: [‘summary text’], and so on. Based on the output of the AI model, the analysis unit automatically adjusts the analysis processing flow and user interface display content, performing multifaceted and multilayered analysis for highly important information and limiting less important information to resource-saving simple analysis. Subsequent processing includes using the user's analysis result viewing history and feedback for continuous learning of the AI model, thereby improving the optimization accuracy of analysis detail control. As a technical effect, the analysis unit realizes individual optimization, resource efficiency, and real-time analysis detail control by AI, compared to conventional uniform analysis processing or manual detail adjustment, and greatly improves system-wide computational efficiency, user satisfaction, and information usefulness. Application fields include driving support for general passenger cars and commercial vehicles, driving education systems, traffic safety awareness applications, business record support for professional drivers, and smart city-linked mobility services.

The analysis unit is configured to apply an appropriate analysis algorithm according to the category of the experience information at the time of analysis. For example, the analysis unit applies a traffic analysis algorithm to information related to road congestion. The analysis unit can also apply a safety analysis algorithm to information related to road safety. Furthermore, the analysis unit can apply the optimal analysis algorithm according to the category of the experience information. By applying the optimal analysis algorithm according to the category of the experience information, the accuracy of analysis is improved. Some or all of the above-described processing in the analysis unit may be performed using AI or without using AI. For example, the analysis unit can apply an appropriate analysis algorithm using an AI model that receives category data of experience information as input. Specifically, the analysis unit acquires input data such as category label assigned to each experience information (e.g., “congestion status,” “safety,” “alert,” “weather impact,” etc.), information content (e.g., natural language text, numerical data, time series array), and related metadata (e.g., location information, time, user attributes). The analysis unit performs preprocessing such as category conversion, feature extraction, and vectorization on these data, and inputs them to an algorithm selection AI model (e.g., multiclass classification AI, rule-based AI, Transformer-based meta-learning AI). Examples of input to the AI include (1) category “congestion status”, content “This road tends to be congested”; (2) category “safety”, content “It is difficult to turn right at this intersection”; (3) category “weather impact”, content “It is slippery on rainy days”, and so on. The AI model outputs structured data such as label of analysis algorithm to be applied (e.g., “traffic flow analysis,” “danger estimation,” “weather impact evaluation”), recommended parameter set (e.g., time series window width, threshold value), and analysis output format (e.g., congestion score, danger label, alert sentence). Examples of output include (1) algorithm: “traffic flow analysis”, parameter: window width 10 minutes, output: congestion score 0.85; (2) algorithm: “danger estimation”, parameter: threshold 0.7, output: danger “high”, and so on. Based on the output of the AI model, the analysis unit automatically branches the analysis processing flow and applies the optimal algorithm for each category, thereby maximizing analysis accuracy, speed, and scalability. Subsequent processing includes using accuracy evaluation of analysis results and user feedback for continuous learning of the AI model, thereby improving the accuracy of algorithm selection. As a technical effect, the analysis unit realizes automatic category judgment, optimal algorithm selection, and real-time analysis branching by AI, compared to conventional uniform algorithm application or manual category judgment, and greatly improves system-wide analysis accuracy, efficiency, and flexibility. Application fields include driving support for general passenger cars and commercial vehicles, driving education systems, traffic safety awareness applications, business record support for professional drivers, and smart city-linked mobility services.

The analysis unit is configured to estimate a user's emotion and adjust the length of analysis based on the estimated emotion of the user. For example, if the user is in a hurry, the analysis unit performs a short and concise analysis. If the user is relaxed, the analysis unit can perform detailed analysis. Furthermore, if the user is excited, the analysis unit can perform visually stimulating analysis. By adjusting the length of analysis according to the user's emotion, analysis results of appropriate length can be provided to the user. Emotion estimation is realized using, for example, an emotion engine or generative AI with emotion estimation functions. Generative AI may be a text generation AI (e.g., LLM) or multimodal generative AI, but is not limited thereto. Some or all of the above-described processing in the analysis unit may be performed using AI or without using AI. For example, the analysis unit can estimate emotion using an AI model that receives the user's emotion data as input. Specifically, the analysis unit simultaneously acquires multimodal data such as facial image frames (224×224 pixel RGB image), heart rate time series data (10-element float array for 10 seconds at 1-second intervals), audio waveform data (16 kHz sampled PCM waveform), utterance text, and accelerometer values, to estimate the user's emotional state. The analysis unit performs preprocessing such as noise removal, normalization, face region extraction, and time series window segmentation on these data, and inputs them to an emotion estimation AI model (multimodal AI combining CNN, LSTM, and Transformer-based natural language understanding AI). Examples of input to the AI model include (1) facial image frame, (2) heart rate time series, (3) utterance text “I am in a hurry and want to know only the key points”, (4) accelerometer values, and so on. The AI model outputs structured data such as emotion label (‘in a hurry’, ‘relaxed’, ‘excited’), emotion intensity score (0.0 to 1.0), and estimation basis. Examples of output include (1) emotion label: ‘in a hurry’, emotion intensity: 0.81; (2) emotion label: ‘relaxed’, emotion intensity: 0.13; (3) emotion label: ‘excited’, emotion intensity: 0.77, and so on. Based on these outputs, the analysis length control module applies rule-based or reinforcement learning-based length optimization algorithms, such as “if in a hurry intensity is 0.7 or higher, display only key points”, “if relaxation intensity is less than 0.3, display detailed analysis”, “if excitement intensity is 0.7 or higher, display visually emphasized analysis with graphs and colors”, and so on. Subsequent processing includes transferring the length and display method of analysis results to the user interface control unit and automatically adjusting the display layout and notification method. As a technical effect, the analysis unit realizes high-precision emotion estimation, multimodal data integration, and real-time adaptive analysis length control by AI, compared to conventional uniform analysis length or manual adjustment, and enables optimal information presentation according to the user's psychological state and situation, greatly improving understanding, satisfaction, and safety. Application fields include driving support for general passenger cars and commercial vehicles, driving education systems, traffic safety awareness applications, stress management support for professional drivers, and smart city-linked mobility services.

The analysis unit is configured to determine the priority of analysis based on the submission timing of the experience information at the time of analysis. For example, the analysis unit preferentially analyzes recently submitted information. The analysis unit can also lower the priority of analysis for information submitted a long time ago. Furthermore, the analysis unit can determine the priority of analysis according to the submission timing of the experience information. By determining the priority of analysis based on the submission timing of the experience information, the latest information can be preferentially analyzed. Some or all of the above-described processing in the analysis unit may be performed using AI or without using AI. For example, the analysis unit can determine the priority of analysis using an AI model that receives submission timing data of experience information as input. Specifically, the analysis unit acquires input data such as submission time assigned to each experience information (e.g., ISO8601 format timestamp), information type, user ID, and past analysis history. The analysis unit performs preprocessing such as time series normalization, category conversion, and feature vectorization on these data, and inputs them to a priority determination AI model (e.g., time series pattern recognition AI, gradient boosting decision tree, Transformer-based time series classification AI). Examples of input to the AI include (1) submission time: 2024-06-01T12:34:56Z, information type “danger spot”; (2) submission time: 2023-12-15T08:20:00Z, information type “congestion”; (3) submission time: 2022-07-10T18:45:30Z, information type “alert”, and so on. The AI model outputs structured data such as analysis priority score (0.0 to 1.0), priority label (“high,” “medium,” “low”), and recommended analysis order list (descending order of submission time). Examples of output include (1) priority: 0.95, label “high”; (2) priority: 0.42, label “medium”; (3) priority: 0.18, label “low”, and so on. Based on the output of the AI model, the analysis unit automatically adjusts the order of the analysis processing queue, preferentially analyzing the latest information to maximize real-time performance, information freshness, and responsiveness of driving support. Subsequent processing includes using the reflection speed of analysis results and user feedback for continuous learning of the AI model, thereby improving the accuracy of priority determination. As a technical effect, the analysis unit realizes time series optimization, real-time priority control, and information freshness maintenance by AI, compared to conventional FIFO analysis or manual priority adjustment, and greatly improves system-wide analysis efficiency, user satisfaction, and safety. Application fields include driving support for general passenger cars and commercial vehicles, driving education systems, traffic safety awareness applications, business record support for professional drivers, and smart city-linked mobility services.

The analysis unit is configured to adjust the order of analysis based on the relevance of the experience information at the time of analysis. For example, the analysis unit preferentially analyzes highly relevant information. The analysis unit can also postpone the analysis of less relevant information. Furthermore, the analysis unit can adjust the order of analysis according to the relevance of the experience information. By adjusting the order of analysis based on the relevance of the experience information, highly relevant information can be preferentially analyzed. Some or all of the above-described processing in the analysis unit may be performed using AI or without using AI. For example, the analysis unit can adjust the order of analysis using an AI model that receives relevance data of experience information as input. Specifically, the analysis unit acquires input data such as relevance score for each experience information (e.g., 0.0 to 1.0), related information ID list, information type, user attributes, and past analysis history. The analysis unit performs preprocessing such as normalization, feature vectorization, and graph structuring on these data, and inputs them to an order adjustment AI model (e.g., graph neural network, Transformer-based relevance estimation AI, rule-based AI). Examples of input to the AI include (1) relevance score 0.91, information ID “A123”; (2) relevance score 0.47, information ID “B456”; (3) relevance score 0.18, information ID “C789”, and so on. The AI model outputs structured data such as analysis order list (descending order of relevance), priority label (“high,” “medium,” “low”), and recommended analysis order (e.g., A123→B456→C789). Examples of output include (1) order list: [‘A123’, ‘B456’, ‘C789’]; (2) priority: A123 “high”, B456 “medium”, C789 “low”, and so on. Based on the output of the AI model, the analysis unit automatically adjusts the order of the analysis processing queue, preferentially analyzing highly relevant information to maximize information usefulness, responsiveness of driving support, and system efficiency. Subsequent processing includes using the usefulness evaluation of analysis results and user feedback for continuous learning of the AI model, thereby improving the accuracy of order adjustment. As a technical effect, the analysis unit realizes high-dimensional relevance estimation, real-time order optimization, and maximization of information value by AI, compared to conventional uniform analysis order or manual adjustment, and greatly improves system-wide analysis efficiency, user satisfaction, and safety. Application fields include driving support for general passenger cars and commercial vehicles, driving education systems, traffic safety awareness applications, business record support for professional drivers, and smart city-linked mobility services.

The storage unit can estimate a user's emotion and determine the priority of information to be accumulated based on the estimated emotion of the user. For example, when the user is feeling stressed, the storage unit preferentially accumulates highly important information. Additionally, when the user is relaxed, the storage unit can preferentially accumulate detailed information. Furthermore, when the user is in a hurry, the storage unit can preferentially accumulate concise information. By determining the priority of information to be accumulated according to the user's emotion, important information can be preferentially stored. Emotion estimation is realized, for example, by using an emotion engine or a generative AI with emotion estimation functionality. Generative AI may include text generation AI (e.g., LLM) or multimodal generative AI, but is not limited to these examples. Some or all of the above-described processing in the storage unit may be performed using AI or without using AI. For example, the storage unit can estimate emotion by inputting the user's emotion data into an AI model for emotion estimation. Specifically, the storage unit simultaneously acquires multimodal data such as face image frames (e.g., 224×224 pixel RGB images), heart rate time series data (a 10-element float array for 10 seconds at 1-second intervals), voice waveform data (PCM waveform sampled at 16 kHz), utterance content during driving (text converted from voice input), and acceleration sensor values (3-axis data: ax, ay, az) to estimate the user's emotional state. The storage unit performs preprocessing such as noise removal, normalization, face region extraction, and time series window segmentation on these data, and inputs them into an emotion estimation AI model (facial expression recognition by CNN, biosignal analysis by LSTM, emotion classification of utterance content by Transformer-based natural language understanding AI). Examples of input to the AI model include (1) face image frames, (2) heart rate time series, (3) utterance text such as “This road is congested and frustrating”, and (4) acceleration sensor values. The AI model outputs structured data such as emotion labels (e.g., ‘stress’, ‘relaxed’, ‘in a hurry’), emotion intensity scores (0.0-1.0), and estimation rationale (facial expression feature vectors, frequency of negative words in utterances). Examples of output include (1) emotion label: ‘stress’, emotion intensity: 0.82; (2) emotion label: ‘relaxed’, emotion intensity: 0.15; (3) emotion label: ‘in a hurry’, emotion intensity: 0.67. Based on these outputs, the storage priority determination module applies rule-based or reinforcement learning-based priority optimization algorithms, such as “if stress intensity is 0.7 or higher, preferentially accumulate information with importance score 0.8 or higher”, “if relaxation intensity is less than 0.3, preferentially accumulate detailed information”, or “if in-a-hurry intensity is 0.6 or higher, preferentially accumulate concise information”. Subsequent processing includes transferring the storage priority determination results to the database management module, which automatically adjusts the storage order and format (e.g., full text for detailed information, summary only for concise information). As a technical effect, compared to conventional uniform information accumulation or manual priority adjustment, the storage unit achieves highly accurate emotion estimation, multimodal data integration, and real-time adaptive storage priority control using AI, greatly improving storage efficiency, information utility, user satisfaction, and overall system operational efficiency. Application fields include driving support for private and commercial vehicles, driver education systems, traffic safety awareness applications, stress management support for professional drivers, and smart city-linked mobility services.

The storage unit can improve the accuracy of accumulation by considering the interrelationship of experience information at the time of accumulation. For example, the storage unit groups related information for accumulation. Additionally, the storage unit can analyze the interrelationship of experience information and preferentially accumulate highly relevant information. Furthermore, the storage unit can improve the accuracy of accumulation by considering the interrelationship of experience information. By considering the interrelationship of experience information, the accuracy of accumulation is improved. Some or all of the above-described processing in the storage unit may be performed using AI or without using AI. For example, the storage unit can accumulate information by inputting interrelationship data of experience information into an AI model that improves accumulation accuracy. Specifically, the storage unit acquires input data such as a related information ID list assigned to each experience information, relevance scores (0.0-1.0), information types (e.g., hazardous locations, congestion, alerts), occurrence time, location information, and user ID as metadata. The storage unit performs preprocessing such as normalization, feature vectorization, and graph structuring on these data, and inputs them into an information interrelationship analysis AI model (graph neural network, Transformer-based relevance estimation AI, clustering AI). Examples of input to the AI include (1) information ID “A123”, related ID list [‘B456’, ‘C789’], relevance score 0.91; (2) information ID “B456”, related ID list [‘A123’], relevance score 0.47; (3) information ID “C789”, related ID list [‘A123’], relevance score 0.18. The AI model outputs structured data such as information group labels (e.g., same event group, time series cluster), accumulation priority scores (0.0-1.0), and recommended accumulation order lists (descending order of relevance). Examples of output include (1) group label: ‘Congestion_Shinjuku_20240601’, priority 0.92; (2) group label: ‘Alert_Ikebukuro_20240601’, priority 0.81. Based on the AI model's output, the database management module automatically adjusts the storage table and index structure, efficiently accumulating highly relevant information as the same group. Subsequent processing utilizes group information for batch retrieval and improved inference accuracy when search or reference requests are made by users or the navigation unit. As a technical effect, compared to conventional simple information accumulation or manual grouping, the storage unit achieves high-dimensional relevance estimation, automatic grouping, and real-time accumulation optimization using AI, greatly improving information utility, search efficiency, and overall system operational efficiency. Application fields include driving support for private and commercial vehicles, driver education systems, traffic safety awareness applications, business record support for professional drivers, and smart city-linked mobility services.

The storage unit can perform accumulation by considering attribute information of the submitter of experience information at the time of accumulation. For example, the storage unit evaluates the reliability of information based on the submitter's driving experience and accumulates it. Additionally, the storage unit can preferentially accumulate highly relevant information by considering the submitter's attribute information. Furthermore, the storage unit can improve the accuracy of accumulation based on the submitter's attribute information. By considering the submitter's attribute information, the accuracy of accumulation is improved. Some or all of the above-described processing in the storage unit may be performed using AI or without using AI. For example, the storage unit can accumulate information by inputting the submitter's attribute information data into an AI model that improves accumulation accuracy. Specifically, the storage unit acquires input data such as driving history recorded for each submitter (e.g., years of driving, mileage, accident history, evaluation score), user attributes (age, gender, occupation, type of driver's license), and past information submission history (number of submissions, number of evaluations, reliability score) as metadata. The storage unit performs preprocessing such as normalization, category conversion, and feature vectorization on these data, and inputs them into a submitter attribute evaluation AI model (gradient boosting decision tree, random forest, Transformer-based multivariate classification AI). Examples of input to the AI include (1) 10 years of driving, evaluation score 0.95; (2) 2 years of driving, evaluation score 0.62; (3) accident history present, evaluation score 0.45. The AI model outputs structured data such as information reliability scores (0.0-1.0), accumulation priority labels (high, medium, low), and recommended accumulation order lists. Examples of output include (1) reliability 0.92, priority “high”; (2) reliability 0.65, priority “medium”; (3) reliability 0.38, priority “low”. Based on the AI model's output, the database management module automatically adjusts whether information is stored and the storage format (full text for high reliability information, summary only for low reliability information). Subsequent processing utilizes reliability scores for controlling display order and notification permission when information is referenced by the navigation unit or sharing unit. As a technical effect, compared to conventional uniform information accumulation or manual reliability evaluation, the storage unit achieves individual optimization, automatic reliability evaluation, and real-time accumulation optimization using AI, greatly improving information utility, overall system operational efficiency, and user satisfaction. Application fields include driving support for private and commercial vehicles, driver education systems, traffic safety awareness applications, business record support for professional drivers, and smart city-linked mobility services.

The storage unit can estimate a user's emotion and adjust the display method of accumulated information based on the estimated emotion of the user. For example, when the user is nervous, the storage unit provides a simple and highly visible display method. Additionally, when the user is relaxed, the storage unit can provide a display method that includes detailed information. Furthermore, when the user is in a hurry, the storage unit can provide a display method that focuses on key points. By adjusting the display method of information according to the user's emotion, it is possible to provide a display that is easy for the user to understand. Emotion estimation is realized, for example, by using an emotion engine or a generative AI with emotion estimation functionality. Generative AI may include text generation AI (e.g., LLM) or multimodal generative AI, but is not limited to these examples. Some or all of the above-described processing in the storage unit may be performed using AI or without using AI. For example, the storage unit can estimate emotion by inputting the user's emotion data into an AI model for emotion estimation. Specifically, the storage unit simultaneously acquires multimodal data such as face image frames (224×224 pixel RGB images), heart rate time series data (a 10-element float array for 10 seconds at 1-second intervals), voice waveform data (PCM waveform sampled at 16 kHz), utterance content text, and acceleration sensor values to estimate the user's emotional state. The storage unit performs preprocessing such as noise removal, normalization, face region extraction, and time series window segmentation on these data, and inputs them into a multimodal AI model combining CNN, LSTM, and Transformer-based natural language understanding AI for emotion estimation. Examples of input to the AI model include (1) face image frames, (2) heart rate time series, (3) utterance text such as “I want to know only the key points because I'm in a hurry”, and (4) acceleration sensor values. The AI model outputs structured data such as emotion labels (‘nervous’, ‘relaxed’, ‘in a hurry’), emotion intensity scores (0.0-1.0), and estimation rationale. Examples of output include (1) emotion label: ‘nervous’, emotion intensity: 0.75; (2) emotion label: ‘relaxed’, emotion intensity: 0.12; (3) emotion label: ‘in a hurry’, emotion intensity: 0.68. Based on these outputs, the display method control module applies rule-based or reinforcement learning-based display optimization algorithms, such as “if nervous intensity is 0.7 or higher, display a simple summary”, “if relaxation intensity is less than 0.3, display detailed analysis”, or “if in-a-hurry intensity is 0.6 or higher, display only key points in a shortened format”. Subsequent processing includes transferring the display method determination results to the user interface control unit, which automatically adjusts the information display layout and notification method (popup, voice guidance, detailed screen). As a technical effect, compared to conventional uniform information display or manual expression adjustment, the storage unit achieves highly accurate emotion estimation, multimodal data integration, and real-time adaptive display control using AI, enabling optimal information presentation according to the user's psychological state and situation, and greatly improving comprehension, satisfaction, and safety. Application fields include driving support for private and commercial vehicles, driver education systems, traffic safety awareness applications, stress management support for professional drivers, and smart city-linked mobility services.

The storage unit can perform accumulation by considering the geographic distribution of experience information at the time of accumulation. For example, the storage unit preferentially accumulates information related to a specific region. Additionally, the storage unit can preferentially accumulate highly relevant information by considering geographic distribution. Furthermore, the storage unit can analyze the geographic distribution of experience information to improve the accuracy of accumulation. By considering geographic distribution, highly relevant information can be preferentially accumulated. Some or all of the above-described processing in the storage unit may be performed using AI or without using AI. For example, the storage unit can accumulate information by inputting geographic distribution data of experience information into an AI model that improves accumulation accuracy. Specifically, the storage unit acquires input data such as GPS location information (latitude, longitude, altitude, timestamp) assigned to each experience information, area ID on the map, past visit history, and area of interest scores as geographic metadata. The storage unit performs preprocessing such as coordinate normalization, map tile ID conversion, and area clustering on these geographic data, and inputs them into a geographic relevance determination AI model (gradient boosting decision tree, random forest, Transformer-based geospatial feature extraction AI). Examples of input to the AI include (1) current location: latitude 35.6895, longitude 139.6917, altitude 44.0, time 2024-06-01T12:34:56Z; (2) area ID: ‘Tokyo_Central_001’; (3) past visit history: ‘Shibuya’, ‘Shinjuku’, ‘Ikebukuro’; (4) area of interest scores: ‘highway section 0.8’, ‘residential area 0.2’. The AI model outputs structured data such as geographic relevance scores (0.0-1.0) for each accumulation candidate information, accumulation eligibility determination (accumulate only if 0.7 or higher), and priority lists (information ID list sorted by relevance). Examples of output include (1) accumulation candidate: ‘Congestion Information_Shinjuku’, relevance 0.92, accumulate; (2) accumulation candidate: ‘Nighttime Visibility Improvement_Ikebukuro’, relevance 0.35, do not accumulate; (3) accumulation candidate: ‘Sudden Braking Alert_Shibuya’, relevance 0.81, accumulate. Based on the AI model's output, the database management module preferentially stores only information with high geographic relevance, and saves only summaries or does not accumulate information with low relevance. Subsequent processing utilizes the content and accumulation rate of stored information as feedback data for continuous learning of the AI model, thereby continuously improving the accuracy of geographic filtering. As a technical effect, compared to conventional uniform information accumulation or manual area selection, the storage unit achieves high-dimensional geospatial feature extraction, individual optimization, and real-time accumulation control using AI, greatly improving information utility, user satisfaction, and overall system operational efficiency. Application fields include driving support for private and commercial vehicles, driver education systems, traffic safety awareness applications, business record support for professional drivers, and smart city-linked mobility services.

The storage unit can improve the accuracy of accumulation based on related literature of experience information at the time of accumulation. For example, the storage unit refers to related literature to evaluate the reliability of information and accumulates it. Additionally, the storage unit can improve the accuracy of accumulation based on related literature of experience information. Furthermore, the storage unit can refer to related literature to determine the priority of information to be accumulated. By referring to related literature, the accuracy of accumulation is improved. Some or all of the above-described processing in the storage unit may be performed using AI or without using AI. For example, the storage unit can accumulate information by inputting related literature data into an AI model that improves accumulation accuracy. Specifically, the storage unit acquires input data such as a related literature ID list assigned to each experience information, literature title, summary text, publication year, author, and reliability score as metadata. The storage unit performs preprocessing such as natural language normalization, feature vectorization, and similarity calculation on these data, and inputs them into a related literature evaluation AI model (Transformer-based natural language understanding AI, similarity calculation AI, gradient boosting decision tree). Examples of input to the AI include (1) related literature title “Risks of Urban Congestion”, summary “Analysis of congestion factors at urban intersections”, reliability 0.92; (2) related literature title “Precautions for Night Driving”, summary “Decreased visibility and accident risk at night”, reliability 0.85. The AI model outputs structured data such as information reliability scores (0.0-1.0), accumulation priority labels (high, medium, low), and recommended accumulation order lists. Examples of output include (1) reliability 0.95, priority “high”; (2) reliability 0.68, priority “medium”. Based on the AI model's output, the database management module automatically adjusts whether information is stored and the storage format (full text for high reliability information, summary only for low reliability information). Subsequent processing utilizes reliability scores for controlling display order and notification permission when information is referenced by the navigation unit or sharing unit. As a technical effect, compared to conventional manual literature reference or uniform information accumulation, the storage unit achieves automatic literature evaluation, reliability determination, and real-time accumulation optimization using AI, greatly improving information utility, overall system operational efficiency, and user satisfaction. Application fields include driving support for private and commercial vehicles, driver education systems, traffic safety awareness applications, business record support for professional drivers, and smart city-linked mobility services.

The navigation unit can estimate a user's emotion and adjust the display method of navigation based on the estimated emotion of the user. For example, when the user is nervous, the navigation unit provides a simple and highly visible display method. Additionally, when the user is relaxed, the navigation unit can provide a display method that includes detailed information. Furthermore, when the user is in a hurry, the navigation unit can provide a display method that focuses on key points. By adjusting the display method of navigation according to the user's emotion, it is possible to provide a display that is easy for the user to understand. Emotion estimation is realized, for example, by using an emotion engine or a generative AI with emotion estimation functionality. Generative AI may include text generation AI (e.g., LLM) or multimodal generative AI, but is not limited to these examples. Some or all of the above-described processing in the navigation unit may be performed using AI or without using AI. For example, the navigation unit can estimate emotion by inputting the user's emotion data into an AI model for emotion estimation. Specifically, the navigation unit simultaneously acquires multimodal data such as face image frames (e.g., 224×224 pixel RGB images), heart rate time series data (a 10-element float array for 10 seconds at 1-second intervals), voice waveform data (PCM waveform sampled at 16 kHz), utterance content during driving (text converted from voice input), and acceleration sensor values (3-axis data: ax, ay, az) to estimate the user's emotional state with high accuracy. The navigation unit performs preprocessing such as noise removal, normalization, face region extraction, and time series window segmentation on these data, and inputs them into an emotion estimation AI model (facial expression recognition by CNN, biosignal analysis by LSTM, emotion classification of utterance content by Transformer-based natural language understanding AI). Examples of input to the AI model include (1) face image frames (e.g., 224×224 pixel RGB images), (2) heart rate time series (e.g., a 10-element float array for 10 seconds at 1-second intervals), (3) utterance text (e.g., “I want to know only the key points because I'm in a hurry”), and (4) acceleration sensor values (e.g., 3-axis data: ax, ay, az). The AI model outputs structured data such as emotion labels (e.g., ‘nervous’, ‘relaxed’, ‘in a hurry’), emotion intensity scores (0.0-1.0), and estimation rationale (facial expression feature vectors, frequency of negative words in utterances). Examples of output include (1) emotion label: ‘nervous’, emotion intensity: 0.75; (2) emotion label: ‘relaxed’, emotion intensity: 0.12; (3) emotion label: ‘in a hurry’, emotion intensity: 0.68. Based on these outputs, the display method control module applies rule-based or reinforcement learning-based display optimization algorithms, such as “if nervous intensity is 0.7 or higher, display a simple summary”, “if relaxation intensity is less than 0.3, display detailed analysis”, or “if in-a-hurry intensity is 0.6 or higher, display only key points in a shortened format”. Subsequent processing includes transferring the display method determination results to the user interface control unit, which automatically adjusts the information display layout and notification method (popup, voice guidance, detailed screen). As a technical effect, compared to conventional uniform information display or manual expression adjustment, the navigation unit achieves highly accurate emotion estimation, multimodal data integration, and real-time adaptive display control using AI, enabling optimal information presentation according to the user's psychological state and situation, and greatly improving comprehension, satisfaction, and safety. Application fields include driving support for private and commercial vehicles, driver education systems, traffic safety awareness applications, stress management support for professional drivers, and smart city-linked mobility services.

The navigation unit can optimize current navigation by referring to past navigation data at the time of navigation. For example, the navigation unit proposes an optimal route based on past navigation data. Additionally, the navigation unit can propose routes that avoid congestion based on past navigation data. Furthermore, the navigation unit can analyze past navigation data to propose the most efficient route. By referring to past navigation data, current navigation can be optimized. Some or all of the above-described processing in the navigation unit may be performed using AI or without using AI. For example, the navigation unit can perform navigation by inputting past navigation data into an AI model that optimizes current navigation. Specifically, the navigation unit acquires past navigation history data (e.g., route history for the past year, departure-destination pairs, passing times, required times, congestion scores, weather information, traffic accident history, and other structured data) from a relational database or NoSQL database. The navigation unit performs preprocessing such as time series feature extraction (e.g., congestion trends by day of week and time zone, required time distribution by route), clustering (e.g., route pattern classification by K-means), and frequency analysis (e.g., aggregation of congestion occurrence frequency) on these history data. AI models such as gradient boosting decision tree (GBDT), random forest, or Transformer-based time series pattern recognition AI can be used. Examples of input to the AI include (1) past route history (e.g., 2024-06-01 08:00 departure A→arrival B, required time 60 minutes, congestion score 0.8), (2) congestion occurrence history (e.g., 2024-06-02 18:30 route C, congestion score 0.9), (3) weather history (e.g., average required time 70 minutes in rainy weather). The AI model outputs structured data such as optimal route proposals (e.g., recommended route ID, required time prediction, congestion avoidance score), recommended reasons (e.g., past congestion avoidance success rate 90%, required time reduction in rainy weather), and recommendation scores (e.g., 0.85). Examples of output include (1) recommended route: route A, recommendation score: 0.92; (2) recommended route: route B, recommendation score: 0.78; (3) recommended route: route C, recommendation score: 0.65. Based on the AI model's output, the user interface control unit automatically adjusts the navigation screen's route candidate display, explanation of recommended reasons, and automatic generation of congestion prediction graphs in real time. Subsequent processing utilizes the user's actually selected route and arrival time as feedback data for continuous learning of the AI model, thereby continuously improving navigation optimization accuracy. As a technical effect, compared to conventional static route guidance or manual history reference, the navigation unit achieves individual optimization, history pattern learning, and real-time route optimization using AI, greatly improving navigation accuracy, driving efficiency, user satisfaction, and overall system operational efficiency. Application fields include driving support for private and commercial vehicles, operation management, driver education systems, traffic safety awareness applications, business record support for professional drivers, and smart city-linked mobility services.

The navigation unit can apply an appropriate navigation method according to the driving situation at the time of navigation. For example, when driving on a highway, the navigation unit applies a navigation method suitable for the specific driving situation. Additionally, when driving in an urban area, the navigation unit can apply a navigation method to avoid congestion. Furthermore, the navigation unit can apply the optimal navigation method according to the driving situation. By applying the optimal navigation method according to the driving situation, navigation accuracy is improved. Some or all of the above-described processing in the navigation unit may be performed using AI or without using AI. For example, the navigation unit can perform navigation by inputting driving situation data into an AI model that applies an appropriate navigation method. Specifically, the navigation unit acquires the user's current driving situation data (e.g., GPS location, speed, direction, acceleration sensor values, road type (highway/urban area/residential area, etc.), weather information, estimated traffic volume) in real time. The navigation unit performs preprocessing such as category conversion, normalization, and feature vectorization on these data, and inputs them into a navigation method selection AI model (e.g., multiclass classification AI, rule-based AI, Transformer-based meta-learning AI). Examples of input to the AI include (1) driving situation: highway, speed 90 km/h, weather: rain; (2) driving situation: urban area, speed 30 km/h, high traffic volume; (3) driving situation: residential area, speed 20 km/h, weather: clear. The AI model outputs structured data such as navigation method labels to be applied (e.g., “highway optimization”, “congestion avoidance”, “residential area safety emphasis”), recommended parameter sets (e.g., guidance frequency, presence of voice guidance, level of detail), and navigation output formats (e.g., route guidance text, alert text, recommendation score). Examples of output include (1) method: “highway optimization”, parameters: high guidance frequency, output: “Please exit at the next interchange”; (2) method: “congestion avoidance”, parameters: voice guidance enabled, output: “You will bypass the congestion section ahead”. Based on the AI model's output, the navigation processing flow and user interface display content are automatically adjusted to provide optimal guidance, warnings, and recommendations in real time for each driving situation. Subsequent processing utilizes the user's guidance acceptance history and feedback for continuous learning of the AI model, thereby improving navigation method selection accuracy. As a technical effect, compared to conventional uniform guidance or manual method switching, the navigation unit achieves automatic situation determination, optimal method selection, and real-time guidance branching using AI, greatly improving navigation accuracy, driving efficiency, safety, and user satisfaction. Application fields include driving support for private and commercial vehicles, operation management, driver education systems, traffic safety awareness applications, business record support for professional drivers, and smart city-linked mobility services.

The navigation unit can estimate a user's emotion and determine the priority of navigation based on the estimated emotion of the user. For example, when the user is feeling stressed, the navigation unit preferentially provides highly important information. Additionally, when the user is relaxed, the navigation unit can preferentially provide detailed information. Furthermore, when the user is in a hurry, the navigation unit can preferentially provide concise information. By determining the priority of navigation according to the user's emotion, important information can be preferentially provided. Emotion estimation is realized, for example, by using an emotion engine or a generative AI with emotion estimation functionality. Generative AI may include text generation AI (e.g., LLM) or multimodal generative AI, but is not limited to these examples. Some or all of the above-described processing in the navigation unit may be performed using AI or without using AI. For example, the navigation unit can estimate emotion by inputting the user's emotion data into an AI model for emotion estimation. Specifically, the navigation unit simultaneously acquires multimodal data such as face image frames (224×224 pixel RGB images), heart rate time series data (a 10-element float array for 10 seconds at 1-second intervals), voice waveform data (PCM waveform sampled at 16 kHz), utterance content text, and acceleration sensor values to estimate the user's emotional state. The navigation unit performs preprocessing such as noise removal, normalization, face region extraction, and time series window segmentation on these data, and inputs them into a multimodal AI model combining CNN, LSTM, and Transformer-based natural language understanding AI for emotion estimation. Examples of input to the AI model include (1) face image frames, (2) heart rate time series, (3) utterance text such as “I want to know only the key points because I'm in a hurry”, and (4) acceleration sensor values. The AI model outputs structured data such as emotion labels (‘stress’, ‘relaxed’, ‘in a hurry’), emotion intensity scores (0.0-1.0), and estimation rationale. Examples of output include (1) emotion label: ‘stress’, emotion intensity: 0.82; (2) emotion label: ‘relaxed’, emotion intensity: 0.15; (3) emotion label: ‘in a hurry’, emotion intensity: 0.67. Based on these outputs, the navigation priority determination module applies rule-based or reinforcement learning-based priority optimization algorithms, such as “if stress intensity is 0.7 or higher, preferentially provide information with importance score 0.8 or higher”, “if relaxation intensity is less than 0.3, preferentially provide detailed information”, or “if in-a-hurry intensity is 0.6 or higher, preferentially provide concise information”. Subsequent processing includes transferring the navigation priority determination results to the user interface control unit, which automatically adjusts the display order and notification method of guidance information (popup, voice guidance, summary guidance screen after driving). As a technical effect, compared to conventional uniform guidance or manual priority adjustment, the navigation unit achieves highly accurate emotion estimation, multimodal data integration, and real-time adaptive guidance priority control using AI, thereby maintaining driver concentration, improving safety, reducing guidance stress, and enhancing overall system usability. Application fields include driving support for private and commercial vehicles, driver education systems, traffic safety awareness applications, stress management support for professional drivers, and smart city-linked mobility services.

The navigation unit can adjust the content of navigation based on changes in driving situation at the time of navigation. For example, when the driving situation changes, the navigation unit adjusts the content of navigation in real time. Additionally, the navigation unit can provide optimal navigation content according to changes in driving situation. Furthermore, the navigation unit can adjust the content of navigation based on changes in driving situation. By adjusting the content of navigation based on changes in driving situation, optimal navigation can be provided in real time. Some or all of the above-described processing in the navigation unit may be performed using AI or without using AI. For example, the navigation unit can perform navigation by inputting driving situation data into an AI model that adjusts navigation content. Specifically, the navigation unit acquires the user's current driving situation data (e.g., GPS location, speed, direction, acceleration sensor values, road type, weather information, estimated traffic volume, flags for sudden acceleration/deceleration events) in real time. The navigation unit performs preprocessing such as category conversion, normalization, and feature vectorization on these data, and inputs them into a navigation content adjustment AI model (e.g., time series pattern recognition AI, rule-based AI, Transformer-based multivariate classification AI). Examples of input to the AI include (1) driving situation: highway, speed 100 km/h, sudden deceleration event occurred; (2) driving situation: urban area, speed 20 km/h, congestion section; (3) driving situation: residential area, speed 15 km/h, weather: rain. The AI model outputs structured data such as navigation content labels (e.g., “sudden deceleration alert”, “congestion avoidance guidance”, “bad weather alert”), recommended guidance text (e.g., “Please slow down ahead”, “You will bypass the congestion section ahead”), and guidance priority scores (e.g., 0.0-1.0). Examples of output include (1) content: “sudden deceleration alert”, guidance text: “Please slow down ahead”, priority 0.91; (2) content: “congestion avoidance guidance”, guidance text: “You will bypass the congestion section ahead”, priority 0.85. Based on the AI model's output, the navigation processing flow and user interface display content are automatically adjusted to provide optimal guidance, warnings, and recommendations in real time in response to changes in driving situation. Subsequent processing utilizes the user's guidance acceptance history and feedback for continuous learning of the AI model, thereby improving navigation content adjustment accuracy. As a technical effect, compared to conventional static guidance or manual content adjustment, the navigation unit achieves automatic situation determination, content optimization, and real-time guidance branching using AI, greatly improving navigation accuracy, driving efficiency, safety, and user satisfaction. Application fields include driving support for private and commercial vehicles, operation management, driver education systems, traffic safety awareness applications, business record support for professional drivers, and smart city-linked mobility services.

The navigation unit can improve the accuracy of navigation by referring to experience information of other users at the time of navigation. For example, the navigation unit proposes an optimal route based on experience information of other users. Additionally, the navigation unit can propose routes that avoid congestion based on experience information of other users. Furthermore, the navigation unit can improve the accuracy of navigation by referring to experience information of other users. By referring to experience information of other users, the accuracy of navigation is improved. Some or all of the above-described processing in the navigation unit may be performed using AI or without using AI. For example, the navigation unit can perform navigation by inputting experience information data of other users into an AI model that improves navigation accuracy. Specifically, the navigation unit acquires experience information collected from other users (e.g., hazardous locations, congestion information, alert history, recommended routes, driving comments, metadata with location information) from relational or NoSQL databases. The navigation unit performs preprocessing such as natural language normalization, location information clustering, reliability evaluation, and relevance score calculation on these experience information, and inputs them into a navigation accuracy improvement AI model (e.g., similarity calculation AI, clustering AI, graph neural network, Transformer-based recommendation AI). Examples of input to the AI include (1) shared experience information: ‘Right turns at this intersection are difficult’, location: latitude 35.6895, longitude 139.6917, reliability 0.92; (2) shared experience information: ‘Visibility is poor on this road at night’, location: latitude 35.7000, longitude 139.7100, reliability 0.85; (3) shared experience information: ‘Section prone to congestion’, location: latitude 35.6800, longitude 139.7600, reliability 0.88. The AI model outputs structured data such as relevance scores (0.0-1.0) for each candidate navigation route, recommended route ID list, and recommended reasons (e.g., many high ratings from other users, high congestion avoidance success rate). Examples of output include (1) recommended route: route A, relevance 0.91, recommended reason: ‘Avoids difficult right turn section’; (2) recommended route: route B, relevance 0.85, recommended reason: ‘Good visibility at night’. Based on the AI model's output, the navigation screen's route candidate display, explanation of recommended reasons, and automatic generation of congestion prediction graphs are adjusted in real time. Subsequent processing utilizes the user's actually selected route and arrival time as feedback data for continuous learning of the AI model, thereby continuously improving navigation accuracy. As a technical effect, compared to conventional static route guidance or manual information reference, the navigation unit achieves aggregation of knowledge from other users, relevance determination, and real-time recommendation using AI, greatly improving navigation accuracy, driving efficiency, user satisfaction, and overall system operational efficiency. Application fields include driving support for private and commercial vehicles, operation management, driver education systems, traffic safety awareness applications, business record support for professional drivers, and smart city-linked mobility services.

The input unit can estimate a user's emotion and adjust the input method based on the estimated emotion of the user. For example, when the user is feeling stressed, the input unit provides a simple interface and minimizes input steps. Additionally, when the user is relaxed, the input unit can provide detailed input options and propose customizable input methods. Furthermore, when the user is in a hurry, the input unit can prioritize voice input to enable rapid input. By adjusting the input method according to the user's emotion, the input unit can provide an input method that is easy for the user to use. Emotion estimation is realized, for example, by using an emotion engine or a generative AI with emotion estimation functionality. Generative AI may include text generation AI (e.g., LLM) or multimodal generative AI, but is not limited to these examples. Some or all of the above-described processing in the input unit may be performed using AI or without using AI. For example, the input unit can estimate emotion by inputting the user's emotion data into an AI model for emotion estimation.

The input unit can select an optimal input method by referring to the user's past input history at the time of input. For example, the input unit automatically displays information that the user has frequently entered in the past as candidates. Additionally, the input unit can preferentially propose input methods (voice, text, etc.) that the user has used in the past. Furthermore, the input unit can predict and propose input methods used at specific times based on the user's past input history. By referring to the user's past input history, the input unit can provide an optimal input method. Some or all of the above-described processing in the input unit may be performed using AI or without using AI. For example, the input unit can select an input method by inputting the user's input history data into an AI model for selecting the optimal input method.

The input unit can estimate a user's emotion and determine the priority of input based on the estimated emotion of the user. For example, when the user is feeling stressed, the input unit preferentially inputs highly important information. Additionally, when the user is relaxed, the input unit can preferentially input detailed information. Furthermore, when the user is in a hurry, the input unit can preferentially input concise information. By determining the priority of input according to the user's emotion, important information can be preferentially input. Emotion estimation is realized, for example, by using an emotion engine or a generative AI with emotion estimation functionality. Generative AI may include text generation AI (e.g., LLM) or multimodal generative AI, but is not limited to these examples. Some or all of the above-described processing in the input unit may be performed using AI or without using AI. For example, the input unit can estimate emotion by inputting the user's emotion data into an AI model for emotion estimation.

The input unit can select an optimal input method by considering the user's device information at the time of input. For example, when the user is using a smartphone, the input unit provides an input method adapted to the screen size. Additionally, when the user is using a tablet, the input unit can provide an input method optimized for a large screen. Furthermore, when the user is using a smartwatch, the input unit can provide a concise and highly visible input method. By considering the user's device information, the input unit can provide an optimal input method. Some or all of the above-described processing in the input unit may be performed using AI or without using AI. For example, the input unit can select an input method by inputting the user's device information into an AI model for selecting the optimal input method.

The sensor unit can estimate a user's emotion and adjust the timing of acquiring sensor information based on the estimated emotion of the user. For example, when the user is feeling stressed, the sensor unit reduces the frequency of acquiring sensor information to allow the user to concentrate on driving. Additionally, when the user is relaxed, the sensor unit can increase the frequency of acquiring sensor information to provide detailed information. Furthermore, when the user is in a hurry, the sensor unit can acquire only important sensor information. By adjusting the timing of acquiring sensor information according to the user's emotion, the sensor unit provides an environment in which the user can concentrate on driving. Emotion estimation is realized, for example, by using an emotion engine or a generative AI with emotion estimation functionality. Generative AI may include text generation AI (e.g., LLM) or multimodal generative AI, but is not limited to these examples. Some or all of the above-described processing in the sensor unit may be performed using AI or without using AI. For example, the sensor unit can estimate emotion by inputting the user's emotion data into an AI model for emotion estimation.

The sensor unit can adjust the type of information to be acquired according to the driving situation at the time of acquiring sensor information. For example, when driving on a highway, the sensor unit acquires sensor information suitable for the specific driving situation. Additionally, when driving in an urban area, the sensor unit can acquire sensor information to avoid congestion. Furthermore, the sensor unit can acquire optimal sensor information according to the driving situation. By adjusting the type of information to be acquired according to the driving situation, the sensor unit can acquire optimal sensor information. Some or all of the above-described processing in the sensor unit may be performed using AI or without using AI. For example, the sensor unit can acquire sensor information by inputting driving situation data into an AI model for adjusting the type of information to be acquired.

The sensor unit can estimate a user's emotion and determine the priority of sensor information based on the estimated emotion of the user. For example, when the user is feeling stressed, the sensor unit preferentially acquires highly important sensor information. Additionally, when the user is relaxed, the sensor unit can preferentially acquire detailed sensor information. Furthermore, when the user is in a hurry, the sensor unit can preferentially acquire concise sensor information. By determining the priority of sensor information according to the user's emotion, important information can be preferentially acquired. Emotion estimation is realized, for example, by using an emotion engine or a generative AI with emotion estimation functionality. Generative AI may include text generation AI (e.g., LLM) or multimodal generative AI, but is not limited to these examples. Some or all of the above-described processing in the sensor unit may be performed using AI or without using AI. For example, the sensor unit can estimate emotion by inputting the user's emotion data into an AI model for emotion estimation.

The sensor unit can improve the accuracy of acquisition by integrating information from other devices at the time of acquiring sensor information. For example, the sensor unit integrates information from other devices to improve the accuracy of sensor information. Additionally, the sensor unit can acquire optimal sensor information based on information from other devices. Furthermore, the sensor unit can improve the accuracy of acquiring sensor information by integrating information from other devices. By integrating information from other devices, the accuracy of acquiring sensor information is improved. Some or all of the above-described processing in the sensor unit may be performed using AI or without using AI. For example, the sensor unit can acquire sensor information by inputting information from other devices into an AI model for improving acquisition accuracy.

The advice unit can estimate a user's emotion and adjust the expression method of advice based on the estimated emotion of the user. For example, when the user is nervous, the advice unit provides advice in a calm voice. When the user is relaxed, the advice unit can provide advice in a cheerful voice. Furthermore, when the user is in a hurry, the advice unit can provide quick and concise advice. By adjusting the expression method of advice according to the user's emotion, advice that is easy for the user to understand can be provided. Emotion estimation is realized, for example, by using an emotion estimation function such as an emotion engine or generative AI. The generative AI may be a text generation AI (for example, LLM) or a multimodal generative AI, but is not limited to these examples. Some or all of the above-described processing in the advice unit may be performed using AI or may be performed without using AI. For example, the advice unit can estimate emotion by inputting the user's emotion data and using an AI model that estimates emotion.

The advice unit can adjust the content of advice according to the driving situation at the time of providing advice. For example, when driving on a highway, the advice unit provides advice suitable for the specific driving situation. When driving in an urban area, the advice unit can provide advice to avoid congestion. Furthermore, the advice unit can provide optimal advice according to the driving situation. By adjusting the content of advice according to the driving situation, optimal advice can be provided. Some or all of the above-described processing in the advice unit may be performed using AI or may be performed without using AI. For example, the advice unit can provide advice by inputting driving situation data and using an AI model that adjusts the content of advice.

The advice unit can estimate a user's emotion and determine the priority of advice based on the estimated emotion of the user. For example, when the user feels stressed, the advice unit preferentially provides highly important advice. When the user is relaxed, the advice unit can preferentially provide detailed advice. Furthermore, when the user is in a hurry, the advice unit can preferentially provide concise advice. By determining the priority of advice according to the user's emotion, important advice can be preferentially provided. Emotion estimation is realized, for example, by using an emotion estimation function such as an emotion engine or generative AI. The generative AI may be a text generation AI (for example, LLM) or a multimodal generative AI, but is not limited to these examples. Some or all of the above-described processing in the advice unit may be performed using AI or may be performed without using AI. For example, the advice unit can estimate emotion by inputting the user's emotion data and using an AI model that estimates emotion.

The advice unit can improve the accuracy of advice by referring to experience information of other users at the time of providing advice. For example, the advice unit provides optimal advice based on experience information of other users. The advice unit can also provide advice to avoid congestion based on experience information of other users. Furthermore, the advice unit can improve the accuracy of advice by referring to experience information of other users. By referring to experience information of other users, the accuracy of advice is improved. Some or all of the above-described processing in the advice unit may be performed using AI or may be performed without using AI. For example, the advice unit can provide advice by inputting experience information data of other users and using an AI model that improves the accuracy of advice.

The sharing unit can estimate a user's emotion and determine the priority of information to be shared based on the estimated emotion of the user. For example, when the user feels stressed, the sharing unit preferentially shares highly important information. When the user is relaxed, the sharing unit can preferentially share detailed information. Furthermore, when the user is in a hurry, the sharing unit can preferentially share concise information. By determining the priority of information to be shared according to the user's emotion, important information can be preferentially shared. Emotion estimation is realized, for example, by using an emotion estimation function such as an emotion engine or generative AI. The generative AI may be a text generation AI (for example, LLM) or a multimodal generative AI, but is not limited to these examples. Some or all of the above-described processing in the sharing unit may be performed using AI or may be performed without using AI. For example, the sharing unit can estimate emotion by inputting the user's emotion data and using an AI model that estimates emotion.

The sharing unit can adjust the content of sharing by considering attribute information of other users at the time of sharing. For example, the sharing unit evaluates and adjusts the reliability of information to be shared based on other users' driving experience. The sharing unit can also preferentially share highly relevant information by considering attribute information of other users. Furthermore, the sharing unit can adjust the content of sharing based on attribute information of other users. By considering attribute information of other users, highly relevant information can be preferentially shared. Some or all of the above-described processing in the sharing unit may be performed using AI or may be performed without using AI. For example, the sharing unit can share information by inputting attribute information data of other users and using an AI model that adjusts the content of sharing.

The sharing unit can estimate a user's emotion and adjust the timing of sharing based on the estimated emotion of the user. For example, when the user feels stressed, the sharing unit postpones the timing of sharing. When the user is relaxed, the sharing unit can perform sharing immediately. Furthermore, when the user is in a hurry, the sharing unit can perform sharing collectively after driving. By adjusting the timing of sharing according to the user's emotion, information can be shared at an appropriate timing. Emotion estimation is realized, for example, by using an emotion estimation function such as an emotion engine or generative AI. The generative AI may be a text generation AI (for example, LLM) or a multimodal generative AI, but is not limited to these examples. Some or all of the above-described processing in the sharing unit may be performed using AI or may be performed without using AI. For example, the sharing unit can estimate emotion by inputting the user's emotion data and using an AI model that estimates emotion.

The sharing unit can improve the accuracy of sharing by integrating information from other devices at the time of sharing. For example, the sharing unit integrates information from other devices to improve the accuracy of sharing. The sharing unit can also provide optimal sharing content based on information from other devices. Furthermore, the sharing unit can improve the accuracy of sharing by integrating information from other devices. By integrating information from other devices, the accuracy of sharing is improved. Some or all of the above-described processing in the sharing unit may be performed using AI or may be performed without using AI. For example, the sharing unit can share information by inputting information from other devices and using an AI model that improves the accuracy of sharing.

The system according to the embodiment is not limited to the above-described examples, and various modifications are possible, for example, as follows.

The navigation system can learn a user's driving style and provide individually optimized advice. For example, when the user frequently applies sudden braking, the navigation system provides advice such as “The upcoming curve is sharp, so please decelerate early.” When the user frequently uses highways, the navigation system can provide advice such as “If you exit at the next interchange, the time to your destination will be shortened.” Furthermore, when the user often drives during specific time periods, the navigation system can propose optimal routes tailored to those time periods. Thus, by providing individualized advice according to the user's driving style, the navigation system can support safer and more efficient driving.

The navigation system can track the user's gaze during driving and provide advice based on the movement of the gaze. For example, when the user misses a road sign ahead, the navigation system provides advice such as “Please pay attention to the next sign.” When the user is confused at an intersection, the navigation system can provide specific instructions such as “When turning right, turn right at the next signal.” Furthermore, when the user is looking at a smartphone while driving, the navigation system can provide safety advice such as “Please refrain from using your smartphone while driving.” Thus, by providing appropriate advice based on the movement of the user's gaze, the navigation system can improve driving safety.

The navigation system can analyze the user's voice during driving and provide advice related to driving. For example, when the user mutters “This road is narrow,” the navigation system provides advice such as “If you turn left at the next intersection, you will reach a wider road.” When the user says “It's congested,” the navigation system can provide advice such as “If you exit at the next exit, you can avoid the congestion.” Furthermore, when the user is wondering where to park, the navigation system can provide advice such as “I will guide you to a nearby parking lot.” Thus, by analyzing the user's voice and providing appropriate advice, the navigation system can improve driving convenience.

The navigation system can monitor the user's heart rate during driving and provide advice based on heart rate fluctuations. For example, when the user's heart rate rises sharply, the navigation system provides advice such as “Take a deep breath and relax.” When the user's heart rate is stable, the navigation system can provide advice such as “Continue driving at your current pace.” Furthermore, when the user's heart rate decreases, the navigation system can provide advice such as “Take a break at the next rest area.” Thus, by providing appropriate advice based on the user's heart rate, the navigation system can support health management during driving.

The navigation system can analyze the user's facial expressions during driving and provide advice based on changes in facial expressions. For example, when the user has an anxious expression, the navigation system provides advice such as “If you turn left at the next intersection, you will get closer to your destination.” When the user has a tired expression, the navigation system can provide advice such as “Take a break at the next rest area.” Furthermore, when the user shows a smile, the navigation system can provide advice such as “Continue driving as you are.” Thus, by providing appropriate advice based on the user's facial expressions, the navigation system can provide psychological support during driving.

The navigation system can analyze the user's music selection during driving and provide advice based on the selection. For example, when the user is listening to relaxing music, the navigation system provides advice such as “Continue driving at your current pace.” When the user is listening to up-tempo music, the navigation system can provide advice such as “Pay attention to the next curve.” Furthermore, when the user is listening to classical music, the navigation system can provide advice such as “Turn right at the next signal.” Thus, by providing appropriate advice based on the user's music selection, the navigation system can support the user's mood during driving.

The navigation system can analyze the user's eating and drinking behavior during driving and provide advice based on such behavior. For example, when the user is drinking a beverage, the navigation system provides advice such as “Take a restroom break at the next rest area.” When the user is eating food, the navigation system can provide advice such as “Refrain from eating and drinking while driving.” Furthermore, when the user is chewing gum, the navigation system can provide advice such as “Continue driving in a relaxed manner.” Thus, by providing appropriate advice based on the user's eating and drinking behavior, the navigation system can improve driving safety.

The navigation system can monitor the temperature inside the vehicle during driving and provide advice based on temperature fluctuations. For example, when the temperature inside the vehicle is high, the navigation system provides advice such as “Use the air conditioner to cool the interior.” When the temperature inside the vehicle is low, the navigation system can provide advice such as “Use the heater to warm the interior.” Furthermore, when the temperature inside the vehicle is comfortable, the navigation system can provide advice such as “Continue driving at the comfortable temperature.” Thus, by providing appropriate advice based on the temperature inside the vehicle, the navigation system can improve comfort during driving.

The navigation system can monitor the remaining fuel level of the vehicle during driving and provide advice based on the remaining fuel level. For example, when the remaining fuel level is low, the navigation system provides advice such as “Refuel at the next gas station.” When the remaining fuel level is sufficient, the navigation system can provide advice such as “Continue driving to your destination.” Furthermore, when the remaining fuel level is decreasing, the navigation system can provide advice such as “Drive with fuel efficiency in mind.” Thus, by providing appropriate advice based on the remaining fuel level, the navigation system can support fuel management during driving.

The navigation system can monitor the tire pressure of the vehicle during driving and provide advice based on tire pressure fluctuations. For example, when the tire pressure is low, the navigation system provides advice such as “Check the tire pressure at the next service area.” When the tire pressure is appropriate, the navigation system can provide advice such as “Continue driving safely.” Furthermore, when the tire pressure is too high, the navigation system can provide advice such as “Adjust the tire pressure at the next service area.” Thus, by providing appropriate advice based on tire pressure, the navigation system can improve vehicle safety during driving.

The following is a brief description of the processing flow of Example of the Embodiment.

Step 1: The reception unit receives experience information from a user. The experience information from the user includes points noticed during driving and cautions. The reception unit records points noticed by the user during driving using voice input or text input. For example, the reception unit converts spoken content by the user into text data using voice recognition technology. Additionally, the reception unit can receive information manually entered by the user via text input.

Step 2: The analysis unit analyzes the information received by the reception unit using AI. The analysis unit extracts specific keywords from voice input or text input using natural language processing technology. For example, the analysis unit divides the entered sentences into words using morphological analysis and extracts important keywords. Furthermore, the analysis unit can analyze the structure of sentences using grammatical analysis to understand their meaning. Moreover, the analysis unit can understand the meaning of the entered information using semantic analysis and generate appropriate advice.

Step 3: The storage unit accumulates the information analyzed by the analysis unit. The storage unit saves the analyzed information using a database. The storage unit can manage the information based on storage format and storage period. For example, the storage unit saves information in a database and can search and retrieve information as needed.

Step 4: The navigation unit performs navigation based on the information accumulated by the storage unit. The navigation unit provides advice to the user in real time. For example, when the user approaches a specific intersection, the navigation unit provides advice such as “Be careful at this intersection as making a right turn is difficult.” Additionally, when the user is about to change lanes, the navigation unit can provide advice such as “It is about time to change lanes.” In this way, information based on the user's driving experience can be utilized to provide more accurate route guidance.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned reception unit, analysis unit, storage unit, and navigation unit is implemented by at least one of, for example, the smart device 14 and the data processing apparatus 12. For example, the reception unit is implemented by a control unit 46A of the smart device 14 and receives voice input or text input from a user. The analysis unit is implemented, for example, by a specific processing unit 290 of the data processing apparatus 12 and analyzes the received information using AI. The storage unit is implemented, for example, by a database 24 of the data processing apparatus 12 and stores the analyzed information. The navigation unit is implemented, for example, by the control unit 46A of the smart device 14 and provides advice to the user in real time. The correspondence between each unit and the apparatus or control unit is not limited to the examples described above and various modifications are possible.

### Second Embodiment

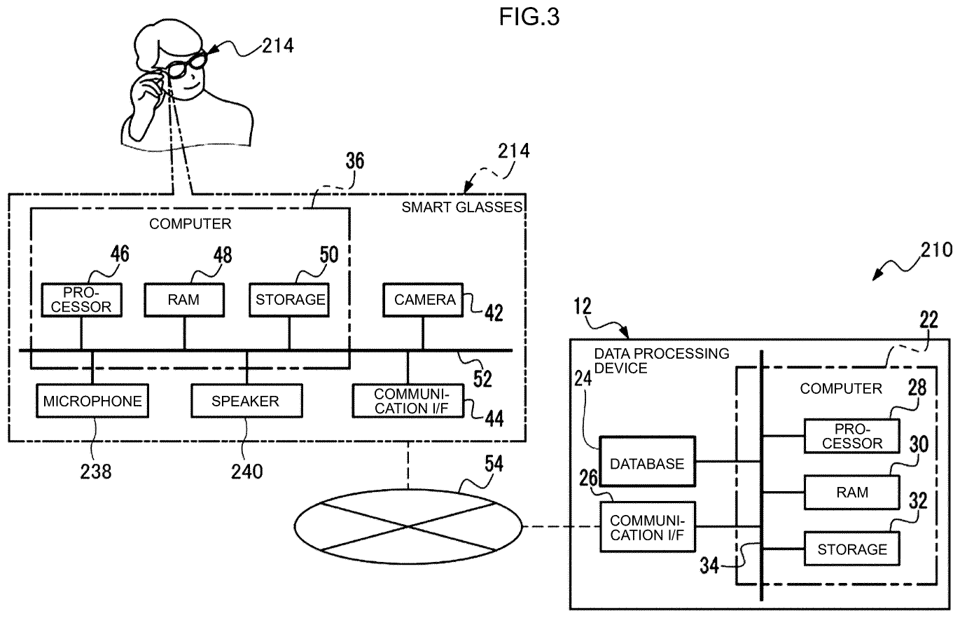

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

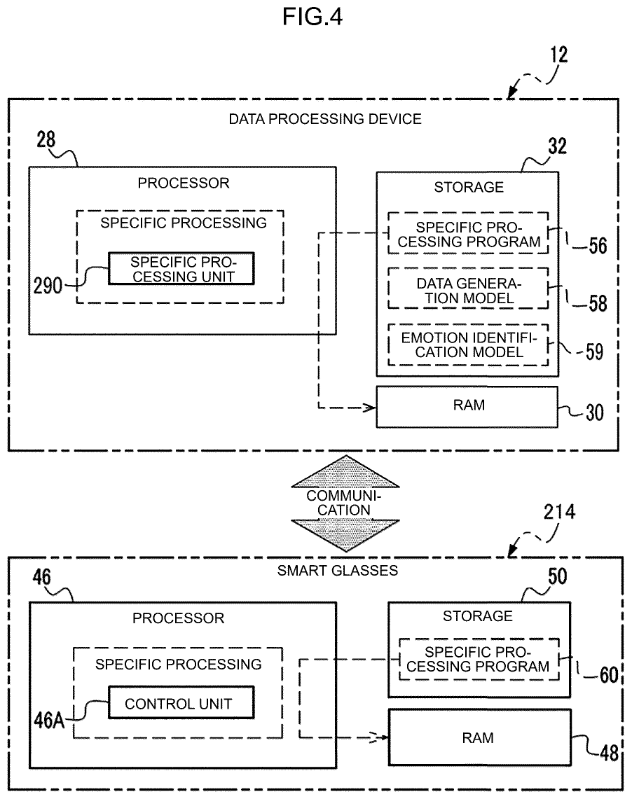

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned reception unit, analysis unit, storage unit, and navigation unit is implemented by at least one of, for example, the smart glasses 214 and the data processing apparatus 12. For example, the reception unit is implemented by a control unit 46A of the smart glasses 214 and receives voice input or text input from a user. The analysis unit is implemented, for example, by a specific processing unit 290 of the data processing apparatus 12 and analyzes the received information using AI. The storage unit is implemented, for example, by a database 24 of the data processing apparatus 12 and stores the analyzed information. The navigation unit is implemented, for example, by the control unit 46A of the smart glasses 214 and provides advice to the user in real time. The correspondence between each unit and the apparatus or control unit is not limited to the examples described above and various modifications are possible.

### Third Embodiment

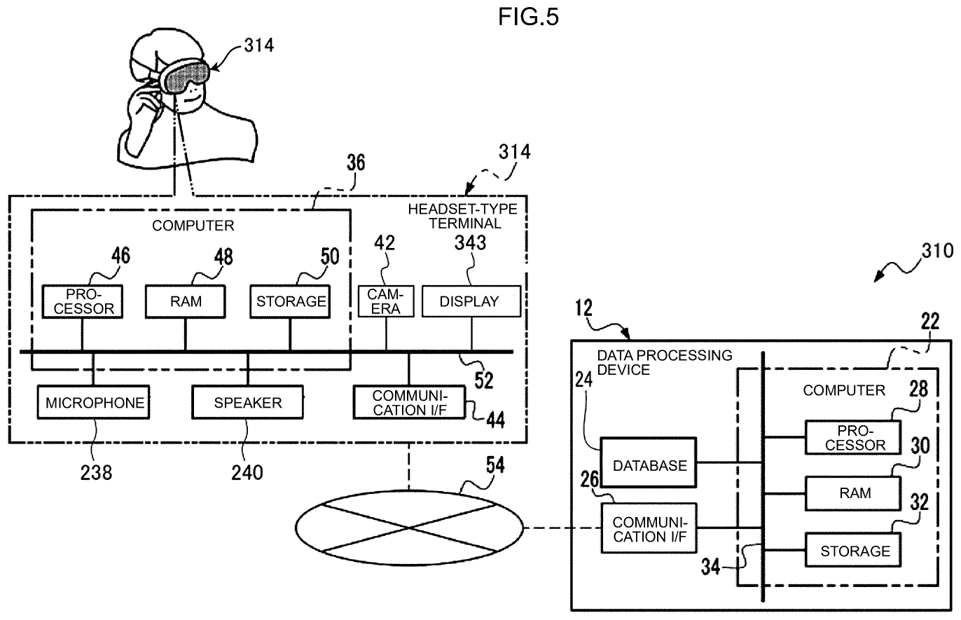

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

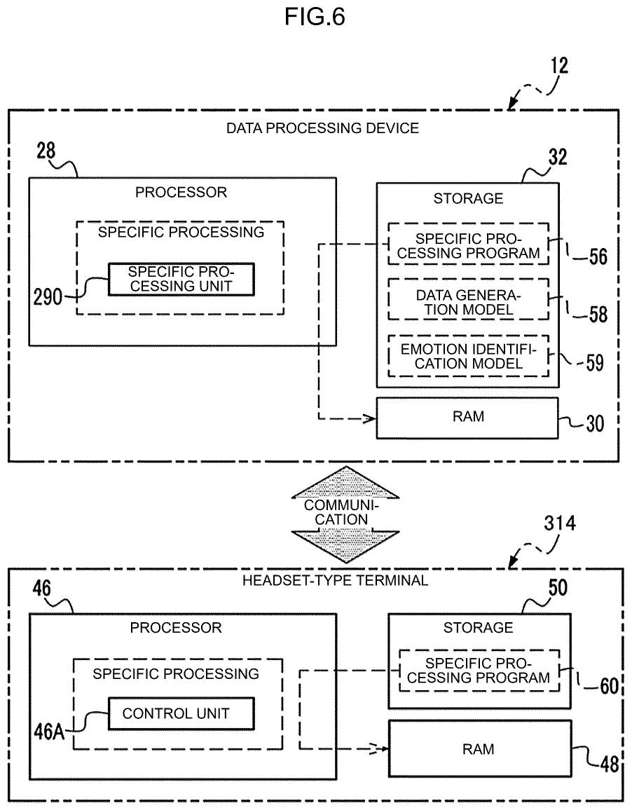

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned reception unit, analysis unit, storage unit, and navigation unit is implemented by at least one of, for example, the headset-type terminal 314 and the data processing apparatus 12. For example, the reception unit is implemented by a control unit 46A of the headset-type terminal 314 and receives voice input or text input from a user. The analysis unit is implemented, for example, by a specific processing unit 290 of the data processing apparatus 12 and analyzes the received information using AI. The storage unit is implemented, for example, by a database 24 of the data processing apparatus 12 and stores the analyzed information. The navigation unit is implemented, for example, by the control unit 46A of the headset-type terminal 314 and provides advice to the user in real time. The correspondence between each unit and the apparatus or control unit is not limited to the examples described above and various modifications are possible.

### Fourth Embodiment

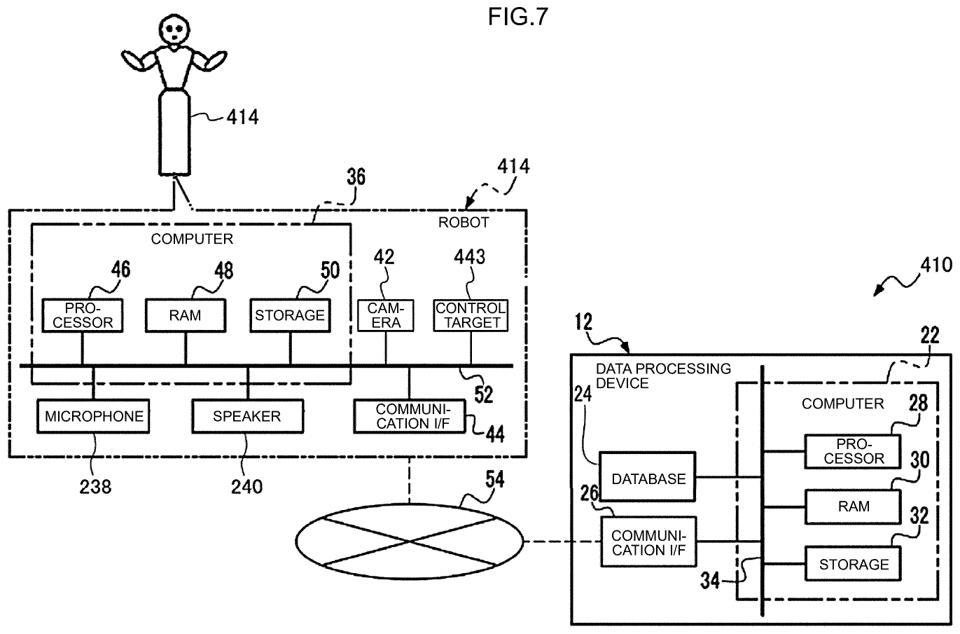

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

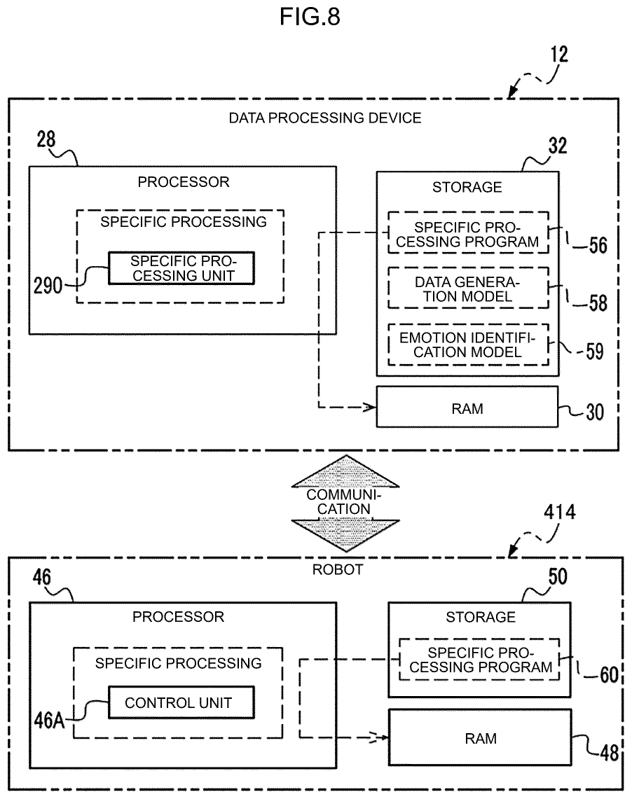

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned reception unit, analysis unit, storage unit, and navigation unit is implemented by at least one of, for example, the robot 414 and the data processing apparatus 12. For example, the reception unit is implemented by a control unit 46A of the robot 414 and receives voice input or text input from a user. The analysis unit is implemented, for example, by a specific processing unit 290 of the data processing apparatus 12 and analyzes the received information using AI. The storage unit is implemented, for example, by a database 24 of the data processing apparatus 12 and stores the analyzed information. The navigation unit is implemented, for example, by the control unit 46A of the robot 414 and provides advice to the user in real time. The correspondence between each unit and the apparatus or control unit is not limited to the examples described above and various modifications are possible.

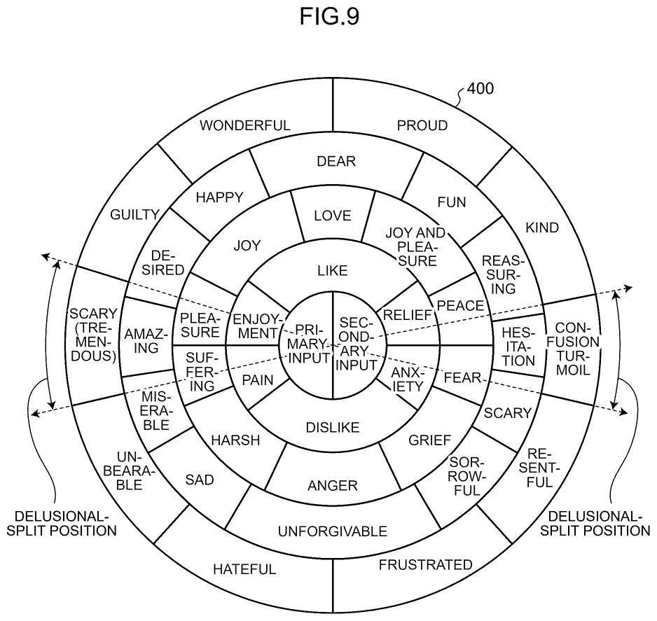

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

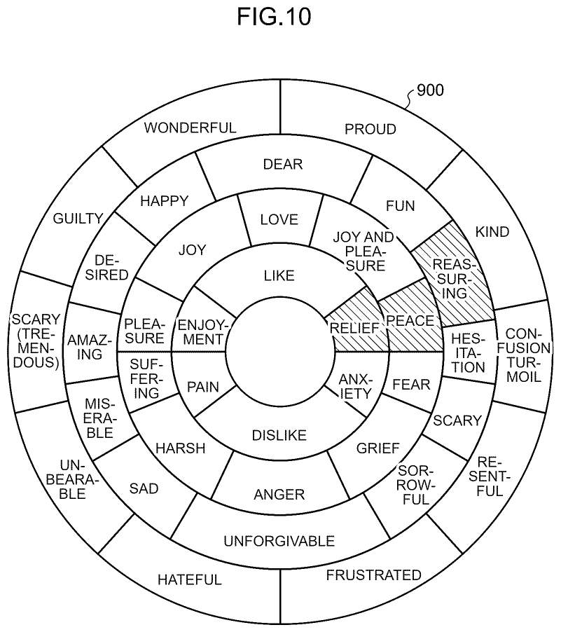

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1)A system comprising: a reception unit configured to receive experience information from a user; an analysis unit configured to analyze the information received by the reception unit; a storage unit configured to accumulate the information analyzed by the analysis unit; and a navigation unit configured to perform navigation based on the information accumulated by the storage unit.
(Supplementary Note 2)The system according to Supplementary Note 1, further comprising an input unit configured to receive voice input or text input.
(Supplementary Note 3)The system according to Supplementary Note 1, further comprising a sensor unit configured to receive location information or sensor information of a smartphone.
(Supplementary Note 4)The system according to Supplementary Note 1, wherein the analysis unit is configured to analyze voice input using natural language processing and extract specific keywords.
(Supplementary Note 5)The system according to Supplementary Note 1, wherein the navigation unit comprises an advice unit configured to provide advice in real time.
(Supplementary Note 6)The system according to Supplementary Note 1, further comprising a sharing unit configured to share information with other users.
(Supplementary Note 7)The system according to Supplementary Note 1, wherein the reception unit is configured to estimate a user's emotion and adjust the timing of receiving experience information based on the estimated emotion of the user.
(Supplementary Note 8)The system according to Supplementary Note 1, wherein the reception unit is configured to analyze a user's past driving history and select an appropriate reception method.
(Supplementary Note 9)The system according to Supplementary Note 1, wherein the reception unit is configured to perform filtering at the time of receiving experience information based on the user's current driving situation or area of interest.
(Supplementary Note 10)The system according to Supplementary Note 1, wherein the reception unit is configured to estimate a user's emotion and determine the priority of experience information to be received based on the estimated emotion of the user.
(Supplementary Note 11)The system according to Supplementary Note 1, wherein the reception unit is configured to preferentially receive highly relevant information based on the user's geographic location information at the time of receiving experience information.
(Supplementary Note 12)The system according to Supplementary Note 1, wherein the reception unit is configured to analyze a user's social media activity and receive relevant information at the time of receiving experience information.
(Supplementary Note 13)The system according to Supplementary Note 1, wherein the analysis unit is configured to estimate a user's emotion and adjust the expression method of analysis based on the estimated emotion of the user.
(Supplementary Note 14)The system according to Supplementary Note 1, wherein the analysis unit is configured to adjust the level of detail of analysis based on the importance of the experience information at the time of analysis.
(Supplementary Note 15)The system according to Supplementary Note 1, wherein the analysis unit is configured to apply an appropriate analysis algorithm according to the category of the experience information at the time of analysis.
(Supplementary Note 16)The system according to Supplementary Note 1, wherein the analysis unit is configured to estimate a user's emotion and adjust the length of analysis based on the estimated emotion of the user.
(Supplementary Note 17)The system according to Supplementary Note 1, wherein the analysis unit is configured to determine the priority of analysis based on the submission timing of the experience information at the time of analysis.
(Supplementary Note 18)The system according to Supplementary Note 1, wherein the analysis unit is configured to adjust the order of analysis based on the relevance of the experience information at the time of analysis.
(Supplementary Note 19)The system according to Supplementary Note 1, wherein the storage unit is configured to estimate a user's emotion and determine the priority of information to be accumulated based on the estimated emotion of the user.
(Supplementary Note 20)The system according to Supplementary Note 1, wherein the storage unit is configured to improve the accuracy of accumulation by considering the interrelationship of experience information at the time of accumulation.
(Supplementary Note 21)The system according to Supplementary Note 1, wherein the storage unit is configured to perform accumulation by considering attribute information of the submitter of the experience information at the time of accumulation.
(Supplementary Note 22)The system according to Supplementary Note 1, wherein the storage unit is configured to estimate a user's emotion and adjust the display method of accumulated information based on the estimated emotion of the user.
(Supplementary Note 23)The system according to Supplementary Note 1, wherein the storage unit is configured to perform accumulation by considering the geographic distribution of experience information at the time of accumulation.
(Supplementary Note 24)The system according to Supplementary Note 1, wherein the storage unit is configured to improve the accuracy of accumulation based on related literature of the experience information at the time of accumulation.
(Supplementary Note 25)The system according to Supplementary Note 1, wherein the navigation unit is configured to estimate a user's emotion and adjust the display method of navigation based on the estimated emotion of the user.
(Supplementary Note 26)The system according to Supplementary Note 1, wherein the navigation unit is configured to optimize current navigation by referring to past navigation data at the time of navigation.
(Supplementary Note 27)The system according to Supplementary Note 1, wherein the navigation unit is configured to apply an appropriate navigation method according to the driving situation at the time of navigation.
(Supplementary Note 28)The system according to Supplementary Note 1, wherein the navigation unit is configured to estimate a user's emotion and determine the priority of navigation based on the estimated emotion of the user.
(Supplementary Note 29)The system according to Supplementary Note 1, wherein the navigation unit is configured to adjust the content of navigation based on changes in driving situation at the time of navigation.
(Supplementary Note 30)The system according to Supplementary Note 1, wherein the navigation unit is configured to improve the accuracy of navigation by referring to experience information of other users at the time of navigation.
(Supplementary Note 31)The system according to Supplementary Note 1, wherein the input unit is configured to estimate a user's emotion and adjust the input method based on the estimated emotion of the user.
(Supplementary Note 32)The system according to Supplementary Note 1, wherein the input unit is configured to select an optimal input method by referring to the user's past input history at the time of input.
(Supplementary Note 33)The system according to Supplementary Note 1, wherein the input unit is configured to estimate a user's emotion and determine the priority of input based on the estimated emotion of the user.
(Supplementary Note 34)The system according to Supplementary Note 1, wherein the input unit is configured to select an optimal input method by considering the user's device information at the time of input.
(Supplementary Note 35)The system according to Supplementary Note 1, wherein the sensor unit is configured to estimate a user's emotion and adjust the timing of acquiring sensor information based on the estimated emotion of the user.
(Supplementary Note 36)The system according to Supplementary Note 1, wherein the sensor unit is configured to adjust the type of information to be acquired according to the driving situation at the time of acquiring sensor information.
(Supplementary Note 37)The system according to Supplementary Note 1, wherein the sensor unit is configured to estimate a user's emotion and determine the priority of sensor information based on the estimated emotion of the user.
(Supplementary Note 38)The system according to Supplementary Note 1, wherein the sensor unit is configured to improve the accuracy of acquisition by integrating information from other devices at the time of acquiring sensor information.
(Supplementary Note 39)The system according to Supplementary Note 1, wherein the advice unit is configured to estimate a user's emotion and adjust the expression method of advice based on the estimated emotion of the user.
(Supplementary Note 40)The system according to Supplementary Note 1, wherein the advice unit is configured to adjust the content of advice according to the driving situation at the time of providing advice.
(Supplementary Note 41)The system according to Supplementary Note 1, wherein the advice unit is configured to estimate a user's emotion and determine the priority of advice based on the estimated emotion of the user.
(Supplementary Note 42)The system according to Supplementary Note 1, wherein the advice unit is configured to improve the accuracy of advice by referring to experience information of other users at the time of providing advice.
(Supplementary Note 43)The system according to Supplementary Note 1, wherein the sharing unit is configured to estimate a user's emotion and determine the priority of information to be shared based on the estimated emotion of the user.
(Supplementary Note 44)The system according to Supplementary Note 1, wherein the sharing unit is configured to adjust the content of sharing by considering attribute information of other users at the time of sharing.
(Supplementary Note 45)The system according to Supplementary Note 1, wherein the sharing unit is configured to estimate a user's emotion and adjust the timing of sharing based on the estimated emotion of the user.
(Supplementary Note 46)The system according to Supplementary Note 1, wherein the sharing unit is configured to improve the accuracy of sharing by integrating information from other devices at the time of sharing.

What is claimed is:

1. A system comprising:
circuitry configured to:
receive, from a client terminal via a communication interface and a packet-switched network, input data comprising at least one of voice data or text data;
analyze the input data using a natural language processing model based on a Transformer architecture to extract at least one of a keyword or a topic label;
store the extracted keyword or topic label together with metadata in a database;
receive, from the client terminal via the communication interface, location data and sensor data;
generate, using a data generation model obtained by deep learning on a neural network, inference data based on the stored keyword or topic label, the location data, and the sensor data; and
transmit the inference data to the client terminal via the communication interface and the packet-switched network, the inference data causing the client terminal to output the inference data to a user.

2. The system according to claim 1,
wherein the input data comprises experience information obtained during vehicle operation, and wherein the inference data comprises route guidance data.

3. The system according to claim 1,
wherein the circuitry is further configured to convert the voice data into text data using a speech recognition model comprising at least one of a convolutional neural network or a recurrent neural network.

4. The system according to claim 1,
wherein the natural language processing model is configured to perform morphological analysis, syntactic analysis, and semantic analysis to extract the keyword or topic label as a probability distribution over a plurality of topic categories.

5. The system according to claim 1,
wherein the metadata comprises at least one of a timestamp, a location identifier, a user identifier, or an emotion estimation value.

6. The system according to claim 1,
wherein the circuitry is further configured to estimate an emotion of the user by applying an emotion identification model to at least one of the voice data, a face image received from the client terminal, or biometric sensor data, and to adjust a timing of receiving the input data based on the estimated emotion.

7. The system according to claim 6,
wherein the circuitry is configured to delay the receiving of the input data when the estimated emotion indicates stress, and to receive the input data immediately when the estimated emotion indicates relaxation.

8. The system according to claim 1,
wherein the circuitry is further configured to analyze a past history of input data associated with the user stored in the database, and to select an input method recommendation based on the past history using at least one of a decision tree, a random forest, or a gradient boosting decision tree.

9. The system according to claim 1,
wherein the circuitry is further configured to estimate an emotion of the user by applying an emotion identification model to sensor data received from the client terminal, and to determine a priority of the input data to be received based on the estimated emotion.

10. The system according to claim 1,
wherein the circuitry is further configured to filter the input data based on at least one of a current activity situation of the user or an area of interest of the user, and to preferentially receive input data having a relevance score exceeding a threshold.

11. The system according to claim 1,
wherein the circuitry is further configured to preferentially receive input data associated with a geographic region corresponding to geographic location information of the user received from the client terminal.

12. The system according to claim 1,
wherein the circuitry is further configured to estimate an emotion of the user and to adjust an expression method of the inference data based on the estimated emotion, such that when the estimated emotion indicates nervousness, the inference data is generated in a simplified format, and when the estimated emotion indicates relaxation, the inference data is generated in a detailed format.

13. The system according to claim 1,
wherein the circuitry is further configured to adjust a level of detail of the inference data based on an importance score associated with the input data, such that detailed inference data is generated for input data having a high importance score and concise inference data is generated for input data having a low importance score.

14. The system according to claim 1,
wherein the circuitry is further configured to apply different analysis algorithms according to a category of the input data.

15. The system according to claim 1,
wherein the circuitry is further configured to determine a priority of generating the inference data based on a submission timing associated with the input data, such that input data having a more recent submission timing is processed with a higher priority.

16. The system according to claim 1,
wherein the circuitry is further configured to improve accuracy of the inference data by considering attribute information of a submitter of the input data, the attribute information comprising at least one of a history duration, an evaluation score, or a past submission count.

17. The system according to claim 1,
wherein the circuitry is further configured to share the inference data with other users via the communication interface, and to adjust content of the sharing based on attribute information of the other users.

18. A system comprising:
a communication interface configured to communicate, via a packet-switched network conforming to at least one of a 5G, Wi-Fi, or Bluetooth communication standard, with a client terminal comprising a touch panel, a microphone, a speaker, a camera having a CMOS image sensor, and a display;
a processor;
a random-access memory;
a memory storing a data generation model obtained by deep learning on a neural network, and an emotion identification model;
a database; and
circuitry configured to:
receive, from the client terminal via the communication interface, input data comprising at least one of voice data captured by the microphone or text data input via the touch panel;
convert the voice data into text data using a speech recognition model comprising at least one of a convolutional neural network or a recurrent neural network;
analyze the text data using a natural language processing model based on a Transformer architecture to extract at least one of a keyword or a topic label;
store the extracted keyword or topic label together with metadata comprising at least one of a timestamp, a location identifier, or a user identifier in the database;
receive, from the client terminal via the communication interface, location data comprising GPS coordinates and sensor data comprising accelerometer values;
estimate an emotion of the user by applying the emotion identification model to at least one of the voice data or a face image captured by the camera;
generate, using the data generation model, inference data based on the stored keyword or topic label, the location data, the sensor data, and the estimated emotion; and
transmit the inference data to the client terminal via the communication interface, the inference data causing the client terminal to output the inference data to the user via at least one of the display or the speaker.

19. The system according to claim 18,
wherein the data generation model comprises at least one of a text generation AI, an image generation AI, or a multimodal generation AI, and wherein the data generation model is a fine-tuned model configured to output inference results from prompts without instructions.

20. A method performed by circuitry of a system comprising a communication interface, a memory storing a data generation model obtained by deep learning on a neural network and an emotion identification model, and a database, the method comprising:
receiving, from a client terminal via the communication interface and a packet-switched network, input data comprising at least one of voice data or text data;
analyzing the input data using a natural language processing model based on a Transformer architecture to extract at least one of a keyword or a topic label;
storing the extracted keyword or topic label together with metadata in the database;
receiving, from the client terminal via the communication interface, location data and sensor data;
generating, using the data generation model, inference data based on the stored keyword or topic label, the location data, and the sensor data; and
transmitting the inference data to the client terminal via the communication interface and the packet-switched network, the inference data causing the client terminal to output the inference data to a user.
